(19) United States
(12) Patent Application Publication
(10) Pub. No.: US 2004/0229728 A1
(43) Pub. Date: Nov. 18, 2004

(54) Control apparatus and method for lock-up clutch of vehicle

(75) Inventors: Koji Oshima, Nagoya-shi (JP); Hiromichi Kimura, Okazaki-shi (JP); Hiroaki Takeuchi, Toyota-shi (JP); Kazuyuki Watanabe, Anjo-shi (JP); Takahiro Kondo, Toyota-shi (JP); Atsushi Ayabe, Toyota-shi (JP); Tatsuya Kawamura, Nisshin-shi (JP); Ayumu Sagawa, Toyota-shi (JP); Toshio Sugimura, Nagoya-shi (JP); Koichi Okuda, Susono-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 10/844,445

(22) Filed: May 13, 2004

(30) Foreign Application Priority Data
May 16, 2003 (JP) 2003-139551
Mar. 18, 2004 (JP) 2004-079074

(51) Int. Cl. F16H 61/58; B60K 41/02

(52) U.S. Cl. 477/176; 477/180

(57) ABSTRACT

In a vehicle having a hydraulic power transmitting device equipped with a lock-up clutch on an output side of the engine, a control apparatus for controlling the lock-up clutch is provided which includes a lock-up clutch control unit that places the lock-up clutch in a slipping state when the vehicle is started so that torque received from the engine is transmitted to a later-stage transmission via the lock-up clutch as well as the hydraulic power transmitting device.

### INCORPORATION BY REFERENCE

The disclosures of Japanese Patent Application Nos. 2003-139551 filed on May 16, 2003 and 2004-79074 filed on Mar. 18, 2004, each including the specification, drawings and abstract, are incorporated herein by reference in their entireties.

### BACKGROUND OF THE INVENTION

1. Field of the Invention

The invention generally relates to an apparatus and a method for controlling a lock-up clutch of a vehicle, and, more particularly, to a technique for transmitting a part of torque generated from an engine to a later-stage transmission via a lock-up clutch as well as a hydraulic power transmitting device when the vehicle is started, thus assuring further improved fuel economy of the vehicle.

2. Description of Related Art

In a known type of a vehicle, a hydraulic power transmitting device is provided which includes a lock-up clutch for directly coupling input and output rotary members of the device, and output torque of the engine is transmitted to an input shaft of the automatic transmission via the hydraulic power transmitting device equipped with the lock-up clutch. The hydraulic power transmitting device, such as a fluid coupling or a torque converter, is arranged to transmit power via a fluid, such as a hydraulic fluid or oil, contained between a pump impeller coupled to the engine and a turbine wheel coupled to the input shaft of the automatic transmission. For this type of vehicle including the hydraulic power transmitting device equipped with the lock-up clutch, various measures for improved fuel economy have been proposed. For example, a slip control device for a lock-up clutch of a vehicle having a hydraulic power transmitting device equipped with the lock-up clutch has been proposed in Japanese Laid-open Patent Publication No. 5-141528 (JP-A-5-141528). When the running condition of the vehicle disclosed in this publication is in a certain low-vehicle-speed region and a certain low-acceleration region, and is thus judged as being in a slip control region, based on the actual vehicle speed (output shaft rotational speed) and the throttle opening θth, from a pre-stored relationship as indicated in FIG. 7 of JP-A-5-141528, the slip control device operates to partially engage the lock-up clutch, i.e., place the lock-up clutch in a slipping state, so as to reduce a rotation loss of the engine and improve the fuel economy or efficiency.

With the known slip control device for the lock-up clutch as described above, the lock-up clutch is normally placed in a released state for prevention of engine stall when the vehicle is stopped, and is also placed in a released state so as to increase the engine speed and improve starting and accelerating capabilities of the vehicle when the vehicle at rest is started. Where the hydraulic power transmitting device is in the form of a torque converter, the torque converter functions to amplify torque in a torque conversion range thereof, thus assuring further improved accelerating capability upon a start of the vehicle.

In the slip control device for the lock-up clutch as described above, however, the lock-up clutch is usually released when the vehicle is started, and therefore the fuel efficiency during starting of the vehicle is determined by the torque capacity that is determined by the specifications of the hydraulic power transmitting device. Thus, the known slip control device does not necessarily provide a sufficiently high fuel efficiency. For example, if torque that is larger than the torque capacity of the hydraulic power transmitting device is to be transmitted from the engine to the device, the torque is only used for an increase or rise of the engine speed, and thus the power of the engine is wastefully consumed, resulting in a reduction in the fuel efficiency.

### SUMMARY OF THE INVENTION

It is therefore an object of the invention to provide a control apparatus for a lock-up clutch of a vehicle having a hydraulic power transmitting device equipped with the lock-up clutch on the output side of the engine, which apparatus controls the lock-up clutch for improved fuel economy or efficiency. It is another object of the invention to provide such a method for controlling the lock-up clutch of the vehicle.

To accomplish the above and/or other object(s), there is provided according to a first aspect of the invention a control apparatus for controlling a lock-up clutch of a vehicle having a hydraulic power transmitting device equipped with the lock-up clutch, the hydraulic power transmitting device being disposed on the output side of the engine of the vehicle, which apparatus comprises a lock-up clutch control unit that places the lock-up clutch in a slipping state when the vehicle is started.

With the control apparatus as described above, the lock-up clutch is placed in a slipping state by the lock-up clutch control unit when the vehicle is started, and therefore torque received from the engine is transmitted to the later stage (e.g., automatic transmission) in a power transmission path via the lock-up clutch as well as the hydraulic power transmitting device when the vehicle is started. Thus, the control apparatus of the invention prevents or suppresses an otherwise possible excessive increase in the engine speed during starting of the vehicle, thus assuring improved fuel economy or efficiency during starting of the vehicle, as compared with the conventional case in which power is transmitted only through the hydraulic power transmitting device upon a start of the vehicle.

According to a second aspect of the invention, there is provided a control apparatus for controlling a lock-up clutch of a vehicle having (a) a hydraulic power transmitting device equipped with the lock-up clutch for directly coupling an input rotary member with an output rotary member, and (b) an automatic transmission operatively coupled to an output side of the hydraulic power transmitting device equipped with the lock-up clutch, for establishing a selected one of a plurality of gear stages by changing a combination of operating states of a plurality of hydraulic friction devices, which apparatus comprises (1) a neutral control unit that places at least one of the hydraulic friction devices for releasing a power transmission path in the automatic transmission in a released state or a slipping state when the vehicle is stopped, and (2) an original pressure control unit that raises an original pressure of the above-indicated at least one hydraulic friction device by a predetermined level during neutral control of the neutral control unit, and gradually reduces the original pressure after the neutral control is finished.

With the control apparatus as described above, the hydraulic friction device for releasing the power transmission path of the automatic transmission is placed in a released or slipping state by the neutral control unit when the vehicle is stopped. Also, when the neutral control for placing the hydraulic friction device in a slipping state is finished, the original pressure of the hydraulic friction device that has been raised by the predetermined value is gradually reduced and returned to a value established prior to the neutral control. When slip starting control for starting the vehicle while slipping the lock-up clutch is performed immediately after the neutral control, therefore, a rapid change in the original pressure used for slip control of the lock-up clutch is avoided, and slip control is favorably carried out without suffering from torque fluctuations due to such a rapid change in the original pressure.

### BRIEF DESCRIPTION OF THE DRAWINGS

The foregoing and/or further objects, features and advantages of the invention will become more apparent from the following description of exemplary embodiments with reference to the accompanying drawings, in which like numerals are used to represent like elements and wherein:

FIG. 1 is a schematic view showing an automatic transmission of a vehicle, which employs a control apparatus for a lock-up clutch of the vehicle as one embodiment of the invention;

FIG. 2 is an operation table explaining the shifting operations of the automatic transmission of FIG. 1;

FIG. 3 is a view explaining input and output signals of an electronic control unit used in the embodiment of FIG. 1;

FIG. 4 is a view showing a principal part of a hydraulic control circuit provided in the automatic transmission of FIG. 1, more specifically, a hydraulic control circuit for lock-up clutch control;

FIG. 5 is a graph showing the relationship between a signal pressure Pₗᵢₙ generated from a linear solenoid valve and a pressure difference ΔP of the lock-up clutch in the hydraulic control circuit of FIG. 4;

FIG. 6 is a functional block diagram explaining the principal control functions of the electronic control unit shown in FIG. 3;

FIG. 7 is a time chart explaining slip control executed by the lock-up clutch control unit of FIG. 6 when the vehicle is started;

FIG. 8 is a graph showing a pre-stored relationship used by a target slip value determining unit of FIG. 6 for determining a target slip speed Nsm;

FIG. 9 is a time chart explaining first line pressure control executed by an original pressure control unit of FIG. 6 when neutral control is finished;

FIG. 10 is a flowchart explaining a principal part of control operations of the electronic control unit shown in FIG. 3, more specifically, a lock-up clutch slip control routine executed when the vehicle is started;

FIG. 11 is a flowchart explaining a principal part of control operations of the electronic control unit shown in FIG. 3, more specifically, an interrupt routine for finishing the lock-up clutch slip control of FIG. 10;

FIG. 12 is a flowchart explaining a principal part of control operations of the electronic control unit shown in FIG. 3, more specifically, a routine for determining conditions for finishing the lock-up clutch slip control;

FIG. 13 is a flowchart explaining a principal part of control operations of the electronic control unit shown in FIG. 3, more specifically, an original pressure control routine in which the first line pressure is gradually reduced immediately after the neutral control is finished;

FIG. 14 is a graph showing characteristics of a torque converter of FIG. 1, in particular, the capacity factor C of the torque converter; and

FIG. 15 is a flowchart explaining the operations of a slip control unit and a slip control restricting unit of another embodiment of the invention; and

FIG. 16 is a time chart explaining the operation of FIG. 15.

### DETAILED DESCRIPTION OF EXEMPLARY EMBODIMENTS

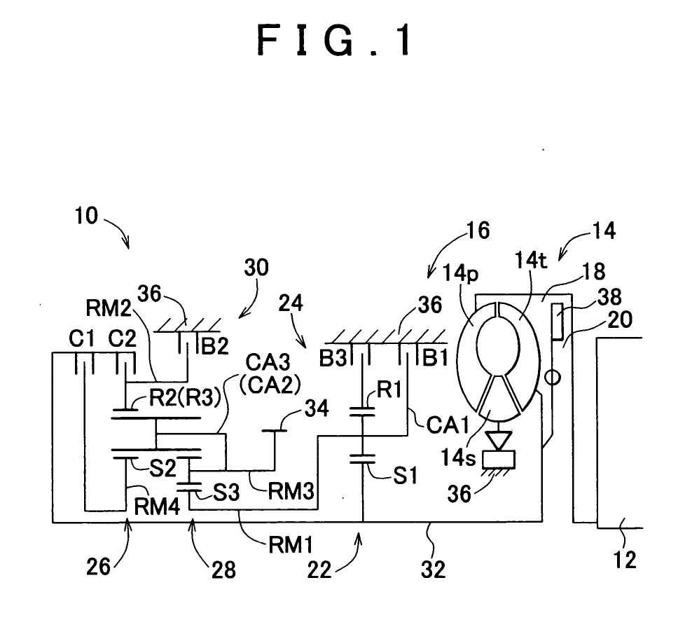

An exemplary embodiment of the invention will be described in detail with reference to the drawings. FIG. 1 schematically shows a driving system 10 of a vehicle, which employs a control apparatus according to one embodiment of the invention. The driving system 10, which is suitably employed in a FF (front engine front drive) vehicle, includes a transversely-mounted automatic transmission 16 and an engine 12 as a power source for running the vehicle. The power of the engine 12 in the form of an internal combustion engine is transmitted to right and left driving wheels, via a torque converter 14 that functions as a hydraulic power transmitting device, automatic transmission 16, a differential gear unit (not shown) and a pair of axles.

The torque converter 14 includes a pump impeller 14p coupled to a crankshaft of the engine 12, a turbine wheel 14t coupled to an input shaft 32 of the automatic transmission 16, and a stator 14s coupled to a transmission case 36 via a one-way clutch. The torque converter 14 is arranged to transmit power from the engine 12 to the automatic transmission 16 by using fluid. The torque converter 14 further includes a lock-up clutch 38 disposed between the pump impeller 14p and the turbine wheel 14t. The lock-up clutch 38 is selectively placed in an engaged state, a slipping state, or a released state by a clutch switching valve 52 and a slip control valve 56 of a hydraulic control circuit 44. As described later in detail, the clutch switching valve 52 is adapted to switch supply of hydraulic fluid to an apply oil chamber 18 and a release oil chamber 20 of the lock-up clutch 38, and the slip control valve 56 is adapted to control a difference ΔP in the pressure between the apply oil chamber 18 and the release oil chamber 20 of the clutch 38. When the lock-up clutch 38 is in a fully engaged state, the pump impeller 14p and the turbine wheel 14t are rotated together as a unit.

The automatic transmission 16 has a first power transmitting portion 24 consisting mainly of a single-pinion type first planetary gear set 22, and a second power transmitting portion 30 consisting mainly of a single-pinion type second planetary gear set 26 and a double-pinion type third planetary gear set 28, such that the first and second power transmitting portions 24, 30 are disposed on the same axis. The automatic transmission 16 is operable to change the speed of rotation of the input shaft 32 and output power from an output gear 34. The input shaft 32 may be in the form of a turbine shaft of a torque converter that is rotated or driven by a driving power source, such as an engine. The output gear 34 may engage with a differential gear unit directly or via a counter shaft, so as to drive right and left driving wheels. It is to be noted that the automatic transmission 16 is constructed substantially symmetrically with respect to the centerline (axis) thereof, and the lower half of the centerline is not illustrated in FIG. 1.

The first planetary gear set 22 of the first power transmitting portion 24 has three rotary elements, i.e., a sun gear S1, a carrier CA1 and a ring gear R1. The sun gear S1 is coupled to and rotated by the input shaft 32, and the ring gear R1 is fixed to the transmission case (housing) 36 via a third brake B3 so as not to be rotated, whereby the carrier CA1 as an intermediate output member is rotated at a reduced speed relative to the input shaft 32 to transmit power to the second power transmitting portion 30. The second and third planetary gear sets 26 and 28 of the second power transmitting portion 30 are partially coupled to each other to provide four rotary elements RM1-RM4. More specifically, a sun gear S3 of the third planetary gear set 28 provides a first rotary element RM1, and a ring gear R2 of the second planetary gear set 26 and a ring gear R3 of the third planetary gear set 28 are coupled to each other to provide a second rotary element RM2. A carrier CA2 of the second planetary gear set 26 and a carrier CA3 of the third planetary gear set 28 are coupled to each other to provide a third rotary element RM3, and a sun gear S2 of the second planetary gear set 26 provides a fourth rotary element RM4. The second and third planetary gear sets 26, 28 constitute a Ravigneaux type planetary gear train in which the carriers CA2 and CA3 are formed from a common member, and the ring gears R2 and R3 are formed from a common member, while a pinion gear of the second planetary gear set 26 also serves as a second pinion gear of the third planetary gear set 28.

The first rotary element RM1 (sun gear S3) is selectively coupled to the case 36 by a first brake B1 and stops rotating, and the second rotary element RM2 (ring gears R2, R3) is selectively coupled to the case 36 by a second brake B2 and stops rotating. The fourth rotary element RM4 (sun gear S2) is selectively coupled to the input shaft 32 via a first clutch C1, and the second rotary element RM2 (ring gears R2, R3) is selectively coupled to the input shaft 32 via a second clutch C2. The first rotary element RM1 (sun gear S3) is coupled integrally with the carrier CA1 of the first planetary gear set 22 as the intermediate output member, and the third rotary element RM3 (carriers CA2, CA3) is coupled integrally with the output gear 34 so as to output rotary power. The first brake B1, second brake B2, third brake B3, first clutch C1 and the second clutch C2 are multiple-disc type hydraulic friction devices that are frictionally engaged by means of hydraulic cylinders or actuators.

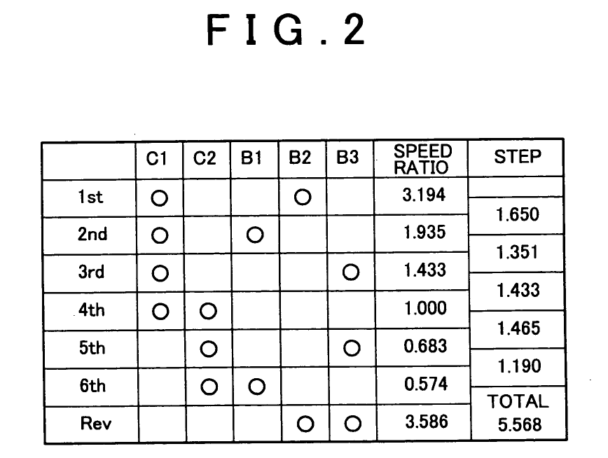

The operation table of FIG. 2 indicates the relationship between each gear stage of the automatic transmission 16 and the operating states of the clutches C1, C2 and brakes B1-B3. In FIG. 2, “O” indicates that the friction device is engaged or applied. The speed ratio of each gear stage is determined by the respective gear ratios ρ1, ρ2, ρ3 of the first planetary gear set 22, second planetary gear set 26 and the third planetary gear set 28. For example, where ρ1≈0.60, ρ2ρ0.46, and ρ3≈0.43, the speed ratios as indicated in FIG. 2 are obtained. In this case, the automatic transmission 16 provides appropriate speed-ratio characteristics, namely, the steps of the speed ratios (i.e., the ratios of the speed ratios of adjacent gear stages) have substantially appropriate values, and the ratio of the largest speed ratio to the smallest speed ratio (the total width of the speed ratio) (=3.194/0.574) is as large as about 5.568, while the reverse gear stage “Rev” has an appropriate speed ratio. Thus, the automatic transmission 16 of the present embodiment establishes six forward speeds and one reverse speed by using two clutches C1, C2 and three brakes B1-B3, and is advantageous over an automatic transmission using three clutches and two brakes, in terms of reduced weight, cost and axial length due to the reduction in the number of clutches. In particular, the single-pinion type second planetary gear set 26 and double-pinion type third planetary gear set 28 of the second power transmitting portion 30 form a Ravigneaux type planetary gear train, and therefore the number of components and the axial length are further reduced.

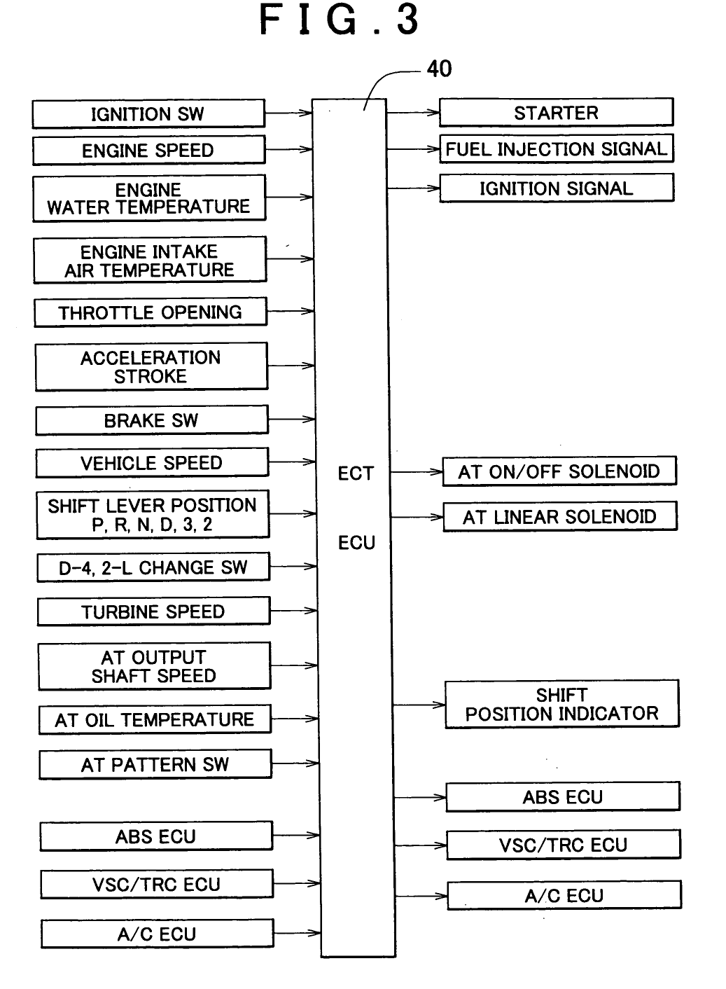

FIG. 3 shows inputs and outputs of an electronic control unit 40 that functions as an automatic shift control device for controlling shifting of the automatic transmission 16. In FIG. 3, the electronic control unit 40 receives an ON signal from an ignition switch, a signal indicative of the engine speed Ne from an engine speed sensor, a signal indicative of the turbine speed Nt or the input shaft rotational speed Nin of the automatic transmission 16 from an input shaft speed sensor, a signal indicative of the engine water temperature Tw from an engine water temperature sensor, a signal indicative of the engine intake air temperature Ta from an engine intake air temperature sensor, a signal indicative of the throttle opening θth from a throttle opening sensor, and a signal indicative of the acceleration stroke θacc from an acceleration stroke sensor. The electronic control unit 40 also receives a signal indicative of a braking operation from a brake switch, a signal indicative of the vehicle speed V (output shaft rotational speed Nout) from a vehicle speed sensor, a signal indicative of the longitudinal position of a shift lever from a shift lever position sensor, a signal indicative of the lateral position of the shift lever from the shift lever position sensor, a signal indicative of the rotational speed Nt of the turbine wheel 14t from a turbine speed sensor, a signal indicative of the rotational speed Nout of the output gear (output shaft) of the automatic transmission 16, a signal indicative of the oil temperature Toil of the automatic transmission 16, a signal indicative of a position to which a shift pattern switch is operated, a signal from an electronic control unit for ABS, a signal from an electronic control unit for VSC/TRC, a signal from an electronic control unit for A/C, and so forth.

The electronic control unit 40 is a microcomputer including, for example, CPU, ROM, RAM and interfaces, and processes input signals according to programs stored in advance in the ROM so as to generate various output signals. The output signals may include a drive signal to a starter, a fuel injection signal to a fuel injector, a signal to a solenoid of an on/off valve for shift control of the automatic transmission 16, a signal to a solenoid of a linear solenoid valve for hydraulic control of the automatic transmission 16, an indication signal to a shift position indicator, a signal to the ABS electronic control unit, a signal to the VSC/TRC electronic control unit, a signal to the A/C electronic control unit, and so forth.

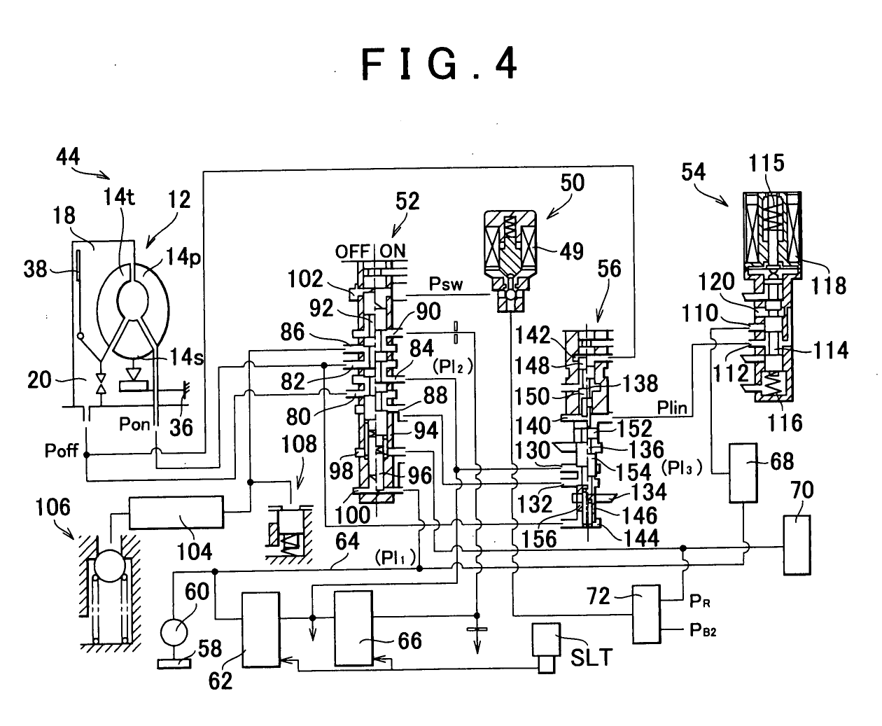

FIG. 4 shows a principal portion of the hydraulic control circuit 44 used for engagement control of the lock-up clutch 38 and shift control of the automatic transmission 16, more specifically, a portion of the hydraulic control circuit 44 associated with engagement control of the lock-up clutch 38. FIG. 4 does not illustrate a hydraulic control circuit for shift control, which controls the automatic transmission 16 to establish a speed ratio selected from six forward speeds and one reverse speed by using solenoids of on/off valves for shift control and linear solenoid valves for hydraulic control.

Referring to FIG. 4, the hydraulic control circuit 44 includes a solenoid-operated valve 50, a clutch switching valve 52, a linear solenoid valve 54 and a slip control valve 56. The solenoid-operated valve 50 is operated to the ON or OFF position by a switching solenoid 49 to generate a switching signal pressure P_{SW}. The clutch switching valve 52 is switched between a releasing position for placing the lock-up clutch 38 in the released state and an engaging position for placing the lock-up clutch 38 in the engaged state, in accordance with the switching signal pressure P_{SW}. The linear solenoid valve 54 generates a signal pressure Pₗᵢₙ for slip control according to drive current I_{SLU} supplied from the electronic control unit 40. The slip control valve 56 controls the amount of slip of the lock-up clutch 38 by adjusting a pressure difference ΔP between the apply oil chamber 18 and the release oil chamber 20 according to the slip control signal pressure Pₗᵢₙ generated from the linear solenoid valve 54.

The hydraulic control circuit 44 includes a pump 60 operable to draw in hydraulic fluid that has returned to a tank (not shown), via a strainer 58, and feed the hydraulic fluid under pressure, as shown in FIG. 4. The pressure of the hydraulic fluid fed under pressure from the pump 60 is regulated into a first line pressure P₁₁ by a relief type first regulating valve 62. The first regulating valve 62 generates the first line pressure P₁₁ which increases in accordance with a throttle pressure proportional to the acceleration stroke or throttle opening supplied from a linear solenoid valve SLT controlled by the electronic control unit 40, and outputs the pressure P₁₁ via a first line oil channel 64. The first line pressure P₁₁ is used as an original pressure of the engagement pressures supplied to the hydraulic friction devices, such as the clutches C1, C2 and brakes B1-B3, provided in the automatic transmission 16. The first line pressure P₁₁ is raised by a certain level during neutral control as described later. A second regulating valve 66, which is a relief type regulating valve, regulates the pressure of the hydraulic fluid flowing from the first regulating valve 62 based on the throttle pressure, thereby to generate a second line pressure P₁₂ that corresponds to the output torque of the engine 12. A third regulating valve 68, which is a pressure reducing valve using the first line pressure P₁₁ as an original pressure, generates a constant third line pressure P₁₃. A manual valve 70 generates a R range pressure P_{R} when the shift lever is placed in the R (reverse) range. An OR valve 72 selects the higher one of the pressure PB₂ that actuates the brake B2 and the R range pressure P_{R}, and generates the selected pressure.

The clutch switching valve 52 has a release port 80 that communicates with the release oil chamber 20 of the lock-up clutch 38, an apply port 82 that communicates with the apply oil chamber 18, an input port 84 to which the second line pressure P₁₂ is supplied, a first discharge port 86 through which the hydraulic fluid in the apply oil chamber 18 is discharged when the lock-up clutch 38 is released, a second discharge port 88 through which the hydraulic fluid in the release oil chamber 20 is discharged when the lock-up clutch 38 is engaged, and a supply port 90 to which a part of the hydraulic fluid discharged from the second regulating valve 66 is supplied for cooling when the lock-up clutch 38 is engaged. The clutch switching valve 52 also has a spool 92 for switching the connection of these ports, a spring 94 that urges the spool 92 toward the OFF position, and a plunger 96 disposed to be abuttable on an end portion of the spool 92 adjacent to the spring 94. The clutch switching valve 52 further has an oil chamber 98 formed between the spool 92 and the plunger 96, which permits the R range pressure P_{R} to be applied to the opposed end faces of the spool 92 and the plunger 96, an oil chamber 100 that receives the first line pressure P₁₁ to be applied to the other end face of the plunger 96, and an oil chamber 102 that receives the switching signal pressure P_{SW} from the solenoid-operated valve 50 so that the signal pressure P_{SW} is applied to the end face of the spool 92 remote from the spring 94 so as to generate thrust to bring the valve 52 into the ON position.

When the solenoid-operated valve 50 is in a non-energized state (OFF state), a ball-like valve body of the valve 50 cuts off communication between the oil chamber 102 of the clutch switching valve 52 and the OR valve 72, and the oil chamber 102 is exposed to a drain pressure. When the solenoid-operated valve 50 is in an energized state (ON state), the valve 50 communicates the oil chamber 102 with the OR valve 72, and applies the switching signal pressure P_{SW} to the oil chamber 102. Namely, when the solenoid-operated valve 50 is in the OFF state, the switching signal pressure P_{SW} is not applied to the oil chamber 102, and the spool 92 is placed in the OFF position under the bias force of the spring 94 and the first line pressure P₁₁ applied to the oil chamber 100, so that the input port 84 and the release port 80 communicate with each other while the apply port 82 and the first discharge port 86 communicate with each other. As a result, the hydraulic pressure P_{off} in the release oil chamber 20 of the lock-up clutch 38 is increased to be higher than the hydraulic pressure Pₒₙ in the apply oil chamber 18, and the lock-up clutch 38 is released. At the same time, the hydraulic fluid in the apply oil chamber 18 is discharged into a drain via the first discharge port 86, an oil cooler 104 and a check valve 106. A relief valve 108 for avoiding an excessive pressure increase is provided between the first discharge port 86 and the oil cooler 104.

When the solenoid-operated valve 50 is in the ON state, on the other hand, the switching signal pressure P_{SW} is applied to the oil chamber 102, and the spool 92 is placed in the ON position against the bias force of the spring 94 and the first line pressure P₁₁ applied to the oil chamber 100, so that the input port 84 and the apply port 82, the release port 80 and the second discharge port 88, and the supply port 90 and the first discharge port 86 communicate with each other, respectively. As a result, the hydraulic pressure Pₒₙ in the apply oil chamber 18 of the lock-up clutch 38 is increased to be higher than the hydraulic pressure P_{off} in the release oil chamber 20, and the lock-up clutch 38 is engaged. At the same time, the hydraulic fluid in the release oil chamber 20 is discharged into a drain via the second discharge port 88 and the slip control valve 56.

The linear solenoid valve 54 is a pressure reducing valve using the constant third line pressure P₁₃ generated by the third regulating valve 68 as an original pressure. The linear solenoid valve 54 generates a slip control signal pressure Pₗᵢₙ which increases with drive current I_{SLU} from the electronic control unit 40, and applies the slip control signal pressure Pₗᵢₙ to the slip control valve 56. The linear solenoid valve 54 has a supply port 110 to which the third line pressure P₁₃ is supplied, an output port 112 that outputs the slip control signal pressure Pₗᵢₙ, and a spool 114 that opens or closes these ports. The linear solenoid valve 54 also has a spring 115 that urges the spool 114 in a valve-closing direction, a spring 116 that urges the spool 114 in a valve-opening direction by using smaller thrust than the spring 115, a solenoid 118 for slip control, which drives the spool 114 in the valve-opening direction according to the drive current I_{SLU}, and an oil chamber 120 that receives a feedback pressure (slip control signal pressure Pₗᵢₙ) for generating thrust on the spool 114 in the valve-closing direction. The spool 114 is operated to a position at which the force generated in the valve-opening direction by the solenoid 118 and the spring 116 is balanced with the force generated in the valve-closing direction by the spring 115 and the feedback pressure.

The slip control valve 56 has a line pressure port 130 to which the second line pressure P₁₂ is supplied, a receiving port 132 that receives the hydraulic fluid in the release oil chamber 20 of the lock-up clutch 38 which is discharged from the second discharge port 88 of the clutch switching valve 52, and a drain port 134 for discharging the hydraulic fluid received by the receiving port 132. The slip control valve 56 also has a spool 136 that is movable between the first position (the lower position in FIG. 3) in which the receiving port 132 and the drain port 134 communicate with each other, and the second position (the upper position in FIG. 3) in which the receiving port 132 and the line pressure port 130 communicate with each other, and a plunger 138 disposed to be abuttable on the spool 136 so as to urge the spool 136 toward the first position. The slip control valve 56 further has a signal pressure oil chamber 140 that receives the slip control signal pressure Pₗᵢₙ so that the pressure Pₗᵢₙ is applied to the plunger 138 and the spool 136 so as to generate thrust on the plunger 138 and the spool 136 in directions in which the plunger 138 and the spool 136 move away from each other, and an oil chamber 142 that receives the hydraulic pressure P_{off} in the release oil pressure 20 of the lock-up clutch 38 so that the hydraulic pressure P_{off} is applied to the plunger 138 so as to generate thrust on the plunger 138, and the spool 136, in a direction toward the first position. The slip control valve 56 further has an oil chamber 144 that receives the hydraulic pressure Pₒₙ in the apply oil chamber 18 of the lock-up clutch 38 so that the hydraulic pressure Pₒₙ is applied to the spool 136 so as to generate thrust on the spool 136 in a direction toward the second position, and a spring 146 received in the oil chamber 144 for urging the spool 136 toward the second position. In operation of the slip control valve 56, when the spool 136 is in the first position, the receiving port 132 and the drain port 134 communicate with each other, and the hydraulic fluid in the release oil chamber 20 of the lock-up clutch 38 is discharged so that a pressure difference ΔP (=Pₒₙ−P_{off}) between the apply oil chamber 18 and the release oil chamber 20 of the lock-up clutch 38 is increased. When the spool 136 is in the second position, on the other hand, the receiving port 132 and the line pressure port 130 communicate with each other, and the second line pressure P₁₂ is supplied to the release oil chamber 20 of the lock-up clutch 38 so that the pressure difference ΔP is reduced.

The plunger 138 is formed with a first land 148 having a cross-sectional area A₁ and a second land 150 having a cross-sectional area A₂ smaller than the cross-sectional area A₁, such that the first land 148 and the second land 150 are arranged in this order as viewed from the oil chamber 142. The spool 136 is formed with a third land 152 having a cross-sectional area A₃, a fourth land 154 having a cross-sectional area A₄ that is smaller than the cross-sectional area A₃ and is equal to the cross-sectional area A₁ of the first land 148, and a fifth land 156 having a cross-sectional area A₅ that is equal to the cross-sectional area A₁, such that the third, fourth and fifth lands 152, 154, 156 are arranged in this order as viewed from the signal pressure oil chamber 140. The cross-sectional areas of these lands have a relationship of A₃>A₁(=A₄=A₅)>A₂. Accordingly, when the clutch switching valve 52 is in the ON position, and the slip control signal pressure Pₗᵢₙ is relatively small such that the relationship as indicated by the following expression (1) is satisfied, the plunger 138 and the spool 136 are in contact with each other and move with each other as a unit, and the pressure difference ΔP between the apply oil chamber 18 and the release oil chamber 20 of the lock-up clutch 38 varies with the slip control signal pressure Pₗᵢₙ. This pressure difference ΔP changes at a relatively small rate of (A₃−A₂)/A₁ with respect to the slip control signal pressure Pₗᵢₙ, according to the following expression (2). In the expression (2), Fₛ represents the bias force of the spring 146.

A₁·P_{off}≧A₂·Pₗᵢₙ (1)

ΔP=Pₒₙ−P_{off}=[(A₃−A₂)/A₁]Pₗᵢₙ−Fₛ/A₁ (2)

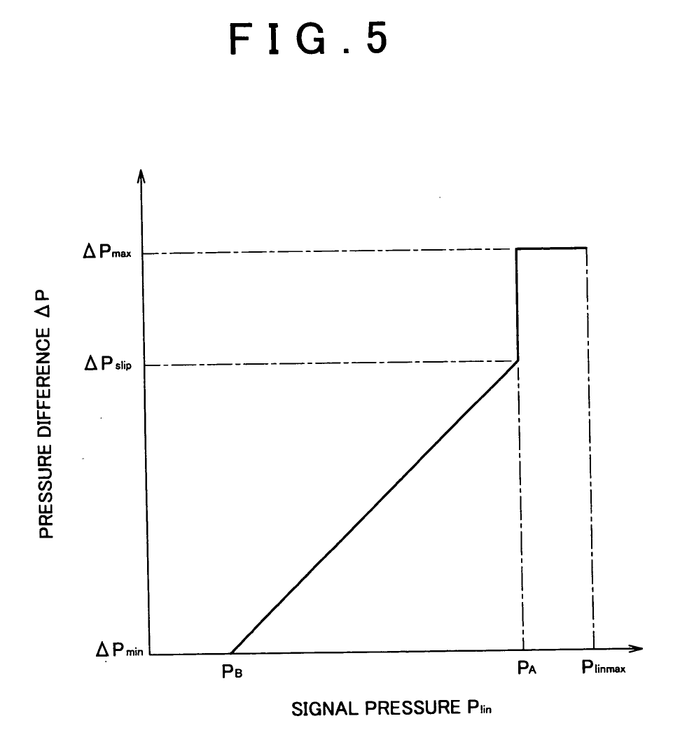

If the slip control signal pressure Pₗᵢₙ becomes greater than a predetermined value P_{A}, the relationship as indicated by the following expression (3) is satisfied. The value P_{A} is determined in advance so as to provide a range ΔPₛₗᵢₚ of change of the pressure difference ΔP that is sufficiently large for slip control of the lock-up clutch 38, and the above-indicated cross-sectional areas and other dimensions of the slip control valve 56 are set so that the relationship of the expression (3) is satisfied when the slip control signal pressure Pₗᵢₙ reaches this value P_{A}. When the slip control signal pressure Pₗᵢₙ is greater than the predetermined value P_{A} and the relationship of the expression (3) is satisfied, therefore, the plunger 138 and the spool 136 are spaced apart from each other, and the spool 136 is moved so as to satisfy the following expression (4). In the condition where the spool 136 is moved so as to satisfy the expression (4), however, the receiving port 132 and drain port 134 of the slip control valve 56 communicate with each other, and the hydraulic pressure P_{off} in the release oil chamber 20 of the lock-up clutch 38 is further reduced down to the atmospheric pressure. As a result, the pressure difference ΔP becomes equal to ΔPₘₐₓ(ΔP=ΔPₘₐₓ=Pₒₙ), and the lock-up clutch 38 is fully engaged. In FIG. 5, the solid line indicates changes in the pressure difference ΔP resulting from the operation of the slip control valve 56, relative to the slip control signal pressure Pₗᵢₙ.

A₁·P_{off}<A₂·Pₗᵢₙ (3)

A₃·Pₗᵢₙ=A₄·Pₒₙ+Fₛ (4)

If the slip control signal pressure Pₗᵢₙ is reduced to be equal to or less than a predetermined value P_{B} at which the following expression (5) is satisfied, the pressure difference ΔP becomes equal to ΔPₘᵢₙ(ΔP=ΔPₘᵢₙ=0), as shown in FIG. 5, and the lock-up clutch 38 is released even though the clutch switching valve 52 is in the ON position.

A₃·Pₒₙ>A₃·Pₗᵢₙ (5)

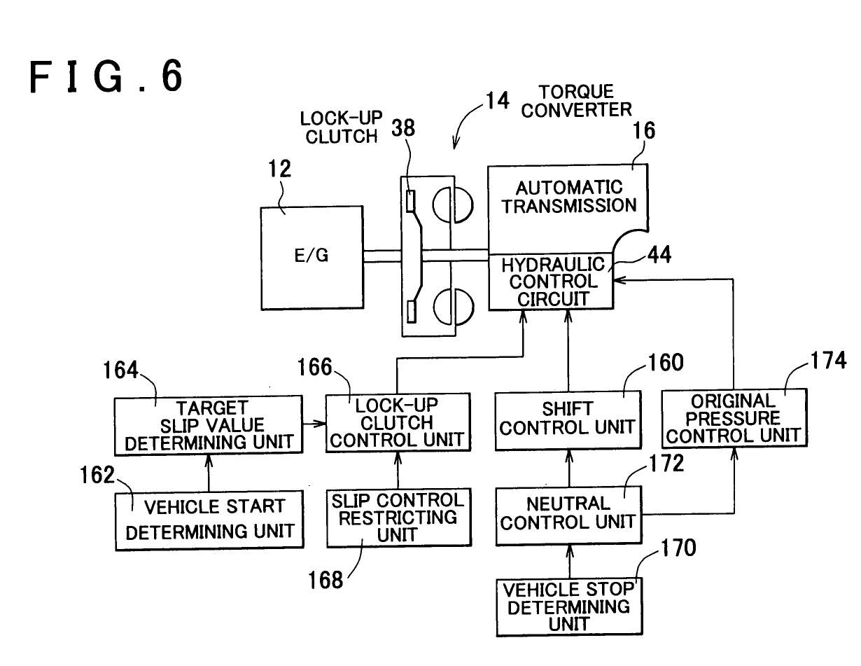

FIG. 6 is a functional block diagram explaining the principal control functions of the electronic control unit 40 as described above. In FIG. 6, a shift control unit 160 determines whether the automatic transmission 16 should be shifted up or down from a pre-stored shift diagram (not shown), based on the actual vehicle speed and the acceleration stroke θacc or throttle opening θth, and drives the solenoids of the on/off valves for shift control in the hydraulic control circuit 44 so as to drive the hydraulic friction device or devices for effectuating shifting of the transmission 16 based on the determination.

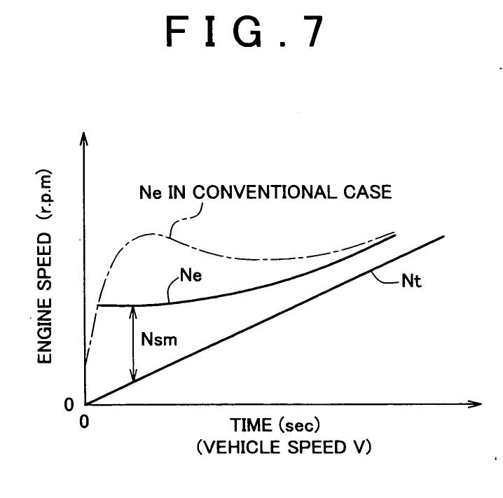

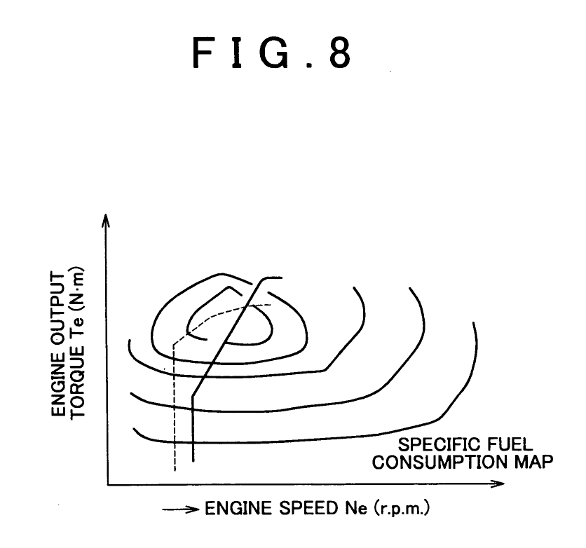

A vehicle start determining unit 162 determines that the vehicle is in a starting condition, for example, when the brake pedal is placed in a non-operated state while the vehicle speed is equal to zero, and the acceleration stroke θacc or throttle opening θth starts increasing from zero. When the vehicle start determining unit 162 determines that the vehicle is in a starting condition, a target slip value determining unit 164 sequentially determines a target slip speed Nsm from a pre-stored relationship, based on the actual acceleration stroke θacc or throttle opening θth, so that the engine speed Ne is kept substantially constant during an initial period as shown in FIG. 7 by way of example, and then becomes gradually close to the turbine speed Nt, or the input shaft rotational speed Nin, that increases with the vehicle speed N. For example, the target slip value determining unit 164 determines a required output torque based on the actual acceleration stroke θacc or throttle opening θth from a relationship indicated by the solid line or broken line in FIG. 8, determines a target engine speed Nem for providing engine output torque Te corresponding to the required output torque, and calculates the target slip speed Nsm (=Nem−Nin) for achieving the target engine speed Nem, based on the actual turbine speed Nt, or the input shaft rotational speed Nin. The relationship indicated by the solid line in FIG. 8 is the optimum running curve plotted in view of the fuel economy and the running performance, and the relationship indicated by the broken line is the optimum fuel economy curve.

When the vehicle start determining unit 162 determines that the vehicle is in a starting condition, a lock-up clutch control unit 166 immediately controls the solenoid-operated valve 50 and the linear solenoid valve 54 in the hydraulic control circuit 44 so as to control the engagement torque of the lock-up clutch 38 by using a feedback control equation, such as an expression (6) indicated below, so that the actual slip speed Ns (=Ne−Nin) becomes equal to the target slip speed Nsm. In the expression (6), e is deviation of the actual slip speed Ns from the target slip speed Nsm, Kₚ is proportional constant, K₁ is integration constant, K_{D} is differential constant, K_{FF} is feed-forward constant, the first term in the right side is a feedback item, and the second term in the right side is a feed-forward item.

I_{SLU}=(K_{P}·e+K₁·e+K_{D}·de/dt)+K_{FF}(f(Te, θth, Nt)) (6)

In the conventional case where the output torque Te of the engine 12 is transmitted to the automatic transmission 16 exclusively through the torque converter 14 without partially engaging (i.e., slipping) the lock-up clutch 38 upon a start of the vehicle, the engine speed Ne rises to a great extent in the initial period as indicated by the one-dot chain line in FIG. 7. In the present embodiment in which the output torque Te of the engine 12 is transmitted to the automatic transmission 16 via the partially engaged (i.e., slipping) lock-up clutch 38 as well as the torque converter 14, on the other hand, the amount of the rise (increase) of the engine speed Ne is limited, and the engine speed Ne is initially kept substantially constant and then becomes gradually close to and increases with the turbine speed Nt that increases with the vehicle speed, as indicated by the solid line in FIG. 7. As a result of the slip control of the lock-up clutch 38 upon a start of the vehicle, the torque converter 14 is prevented from receiving, from the engine 12, torque that is larger than the transmitted torque capacity of the torque converter 14. Namely, the lock-up clutch control unit 166 performs slip control of the lock-up clutch 38 so as to prevent the torque converter 14 from receiving, from the engine 12, torque that is larger than the transmitted torque capacity of the torque converter 14, i.e., the capacity factor of the torque converter 14, when the vehicle is started. While the lock-up clutch control unit 166 places the lock-up clutch 38 in the released state while the vehicle is stopped before its start, the control unit 166 may place the lock-up clutch 38 in the engaged state so as to quickly start slip control upon a start of the vehicle in the case where a neutral control unit 172 as described later performs neutral control for reducing creep torque by releasing or substantially releasing the power transmission path in the automatic transmission 16.

A slip control restricting unit 168 restricts slip control of the lock-up clutch 38 by the lock-up clutch control unit 166 at the time of a start of the vehicle when the running condition of the vehicle becomes a predetermined condition, such as a predetermined decelerating running condition associated with the probability of an engine stall, a predetermined accelerating condition associated with deterioration of the drivability or driving performance, a condition in which the work of the lock-up clutch 38 becomes equal to or greater than a predetermined value, which condition is associated with the durability of the lock-up clutch 38.

The predetermined decelerating running condition of the vehicle means a condition in which the probability of an engine stall upon a start of the vehicle is increased, namely, an engine stall is more likely to occur when the vehicle is started. For example, the vehicle is determined to be in the predetermined decelerating condition when at least one of the following conditions is satisfied: (a) the deceleration of the vehicle is equal to or larger than a predetermined value, (b) a braking device of the vehicle is actuated, (c) a negative change in the engine speed Ne, or the rate of reduction of the engine speed Ne, is equal to or larger than a predetermined value, (d) the rate of reduction of the acceleration stroke θacc or throttle opening θth is equal to or larger than a predetermined value, (e) the accelerator pedal is placed in a non-operated position, (f) a fault of a sensor, such as a vehicle speed sensor, a rotational speed sensor, or an engine speed sensor, which is involved in slip control is detected, (g) the engine speed Ne becomes equal to or lower than the turbine speed Nt of the torque converter 14, (h) the distance from a forward vehicle becomes equal to or less than a predetermined value, and (i) the output shaft rotational speed Nout, or the vehicle speed V, is increased to be equal to or higher than a predetermined value. The slip control restricting unit 168 stops slip control of the lock-up clutch 38 by the lock-up clutch control unit 166 when the above-described condition that increases the probability of an engine stall upon a start of the vehicle occurs.

The predetermined accelerating condition of the vehicle means a condition in which the drivability is deteriorated when the vehicle is started. For example, the vehicle is determined to be in the predetermined accelerating condition when at least one of the following conditions is satisfied: (a) the acceleration stroke θacc or throttle opening θth becomes equal to or larger than a predetermined value, (b) the rate of increase of the acceleration stroke θacc or throttle opening θth becomes equal to or larger than a predetermined value, (c) the vehicle starts running on an up-hill or the slope of an up-hill on which the vehicle is running becomes equal to or larger than a predetermined value, and (d) the manual operation mode of shifting of the automatic transmission 16 is selected. The slip control restricting unit 168 reduces the torque capacity of the lock-up clutch 38 under slip control when the acceleration stroke θacc or throttle opening θth becomes equal to or larger than the predetermined value, and stops slip control of the lock-up clutch 38 by the lock-up clutch control unit 166 when the rate of increase of the acceleration stroke θacc or throttle opening θth becomes equal to or larger than the predetermined value. The slip control restricting unit 168 reduces the torque capacity of the lock-up clutch 38 under slip control in accordance with the slope of the up-hill, and stops slip control of the lock-up clutch 38 by the lock-up clutch control unit 166 when the slope of the up-hill becomes equal to or larger than the predetermined value. The slip control restricting unit 168 stops slip control of the lock-up clutch 38 by the lock-up clutch control unit 166 when the manual operation mode of shifting of the automatic transmission 16 is selected, for example, when the shifting mode is switched from an automatic shifting mode to a manual shifting mode or when the shift lever is operated from the D position to any of the 3, 2 and L positions.

The condition in which the work of the lock-up clutch 38 becomes equal to or larger than the predetermined value means a condition in which a pre-set condition or conditions for determining a state that reduces the durability of the friction material of the lock-up clutch 38 is/are satisfied. For example, the above condition is established when at least one of the following conditions is satisfied: (a) the estimated (or calculated) amount of heat absorbed by the lock-up clutch 38 exceeds a predetermined value, and/or the heat absorption amount or its integral value is kept larger than a predetermined value for a predetermined length of time or longer, (b) the temperature Toil of the hydraulic fluid in the automatic transmission 16 becomes equal to or higher than a predetermined value, and (c) the acceleration of the vehicle is equal to or smaller than a predetermined value when the acceleration stroke θacc is in a predetermined range. The condition that the acceleration of the vehicle is equal to or smaller than a predetermined value when the acceleration stroke θacc is in a predetermined range means a condition or state in which the acceleration of the vehicle or the vehicle speed measured a certain time after starting of the vehicle does not reach or exceed an acceleration or vehicle speed value that is commensurate with the acceleration stroke θacc even though the acceleration stroke θacc is in an acceleration range equal to or larger than a predetermined value. This condition may be established when the running resistance of the vehicle is high, for example, while the vehicle is running on an up-hill or running with the parking or emergency brake being applied, and the friction load and work of the lock-up clutch 38 are large due to the high running resistance. Here, the acceleration stroke θacc is used to mean a parameter indicative of the engine load, which is equivalent to the throttle opening θth, flow rate of intake air, fuel injection amount, or the like.

The slip control restricting unit 168 stops slip control of the lock-up clutch 38 by the lock-up clutch control unit 166 when the estimated (or calculated) amount of heat absorbed (or generated) by the lock-up clutch 38 exceeds the predetermined value, and/or the heat absorption amount or its integral value is kept larger than the predetermined value for the predetermined time or longer. Also, the slip control restricting unit 168 stops slip control of the lock-up clutch 38 by the lock-up clutch control unit 166 when the oil temperature Toil of the automatic transmission 16 becomes equal to or higher than the predetermined value. Also, the slip control restricting unit 168 stops slip control of the lock-up clutch 38 by the lock-up clutch control unit 166 if the acceleration of the vehicle is equal to or smaller than the predetermined value when the acceleration stroke θacc is in the predetermined range

Referring again to FIG. 6, a vehicle stop determining unit 170 determines that the vehicle is in a stopped state, for example, when the output shaft rotational speed Nout, or the vehicle speed V, is equal to or lower than a predetermined stop judgment value. A neutral control unit 172 executes neutral control to place the power transmission path of the automatic transmission 16 in a substantially released state so as to improve the fuel economy by reducing the load of the engine 12 during idling or reduce creep torque, for example, when the vehicle stop determining unit 170 determines that the vehicle is stopped, the acceleration stroke θacc or throttle opening θth is equal to zero, the shift lever is in the D position, and the vehicle is on a flat road. In the neutral control, the clutch C1 and brake B2 as hydraulic friction devices for establishing the 1st-speed gear stage are substantially released (i.e., placed in a slightly slipping state immediately before engagement) and engaged, respectively, so as to establish a start standby state in which the power transmission path of the automatic transmission 16 is in a substantially released or disconnected state, but the vehicle can be immediately started upon engagement of the clutch C1 from the half-engaged or slipping state.

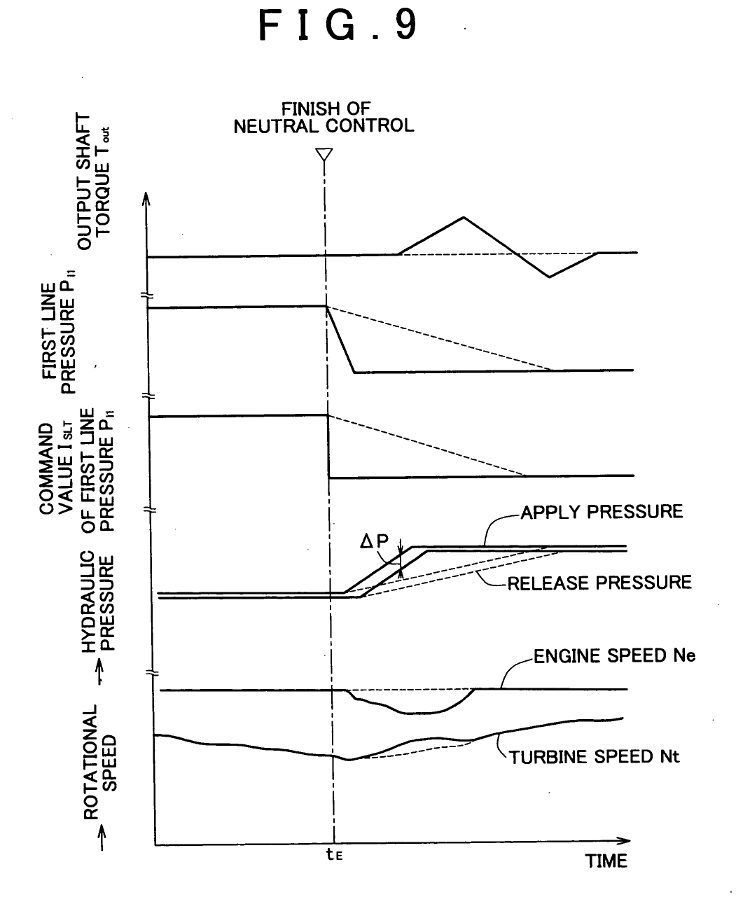

An original pressure control unit 74 controls, via the linear solenoid valve SLT, the first regulating valve 62 or the second regulating valve 66 that regulates the first line pressure P₁₁ used as an original pressure of each hydraulic friction device in the automatic transmission 16, basically in accordance with the input torque Tin which may be typically represented by the acceleration stroke θacc or the throttle opening θth. While the neutral control is being executed by the neutral control unit 172 during stop of the vehicle, the original pressure control unit 74 raises the first line pressure P₁₁ by a predetermined level as shown in FIG. 9 so as to ensure controllability of the engagement pressure of the clutch C1 subjected to the neutral control. When the vehicle is started with the lock-up clutch 38 slipping after the neutral control is finished, the original pressure control unit 74 gradually and linearly reduces the first line pressure P₁₁ at a predetermined rate of change, as indicated by a broken line in FIG. 9 by way of example.

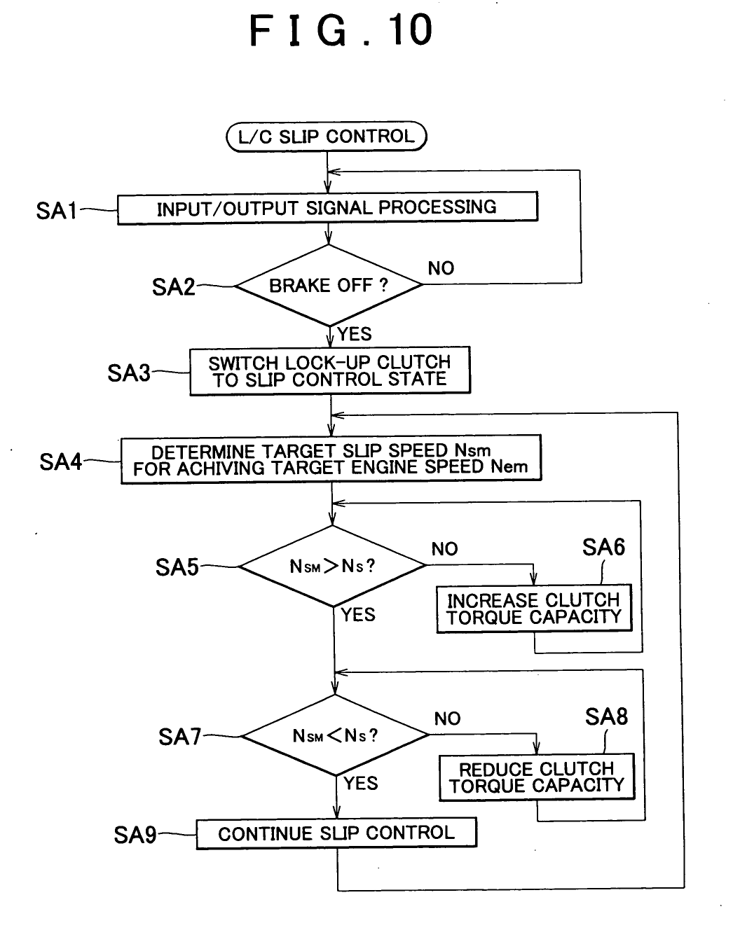

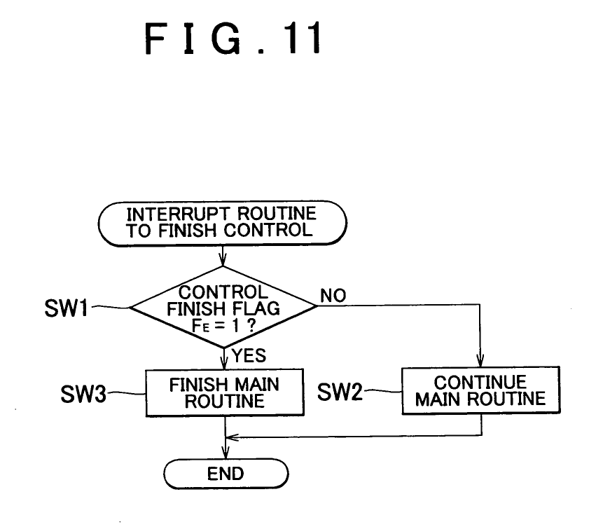

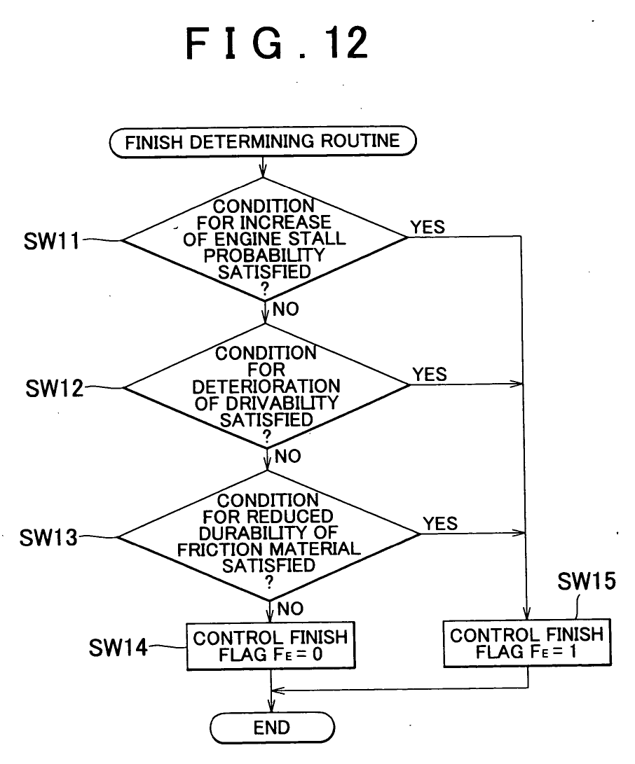

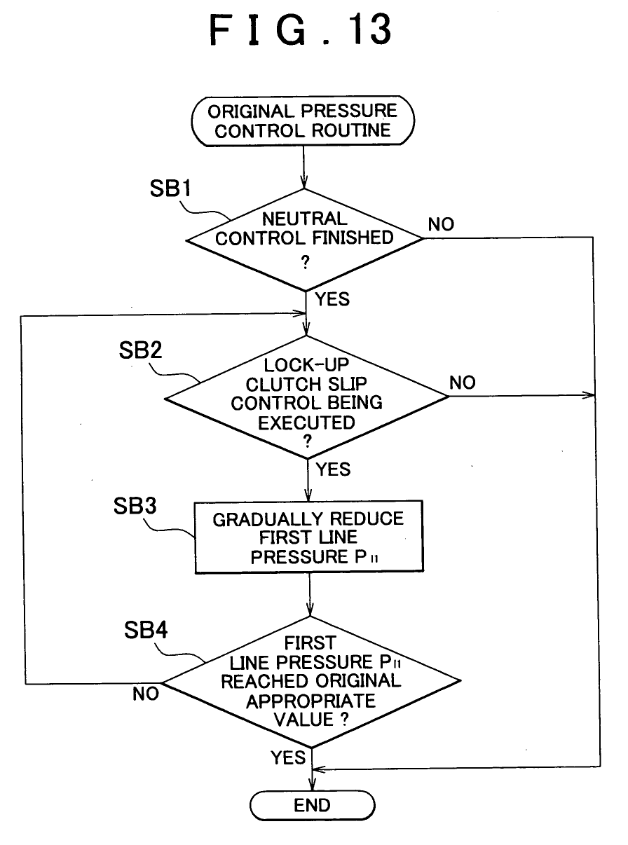

FIG. 10, FIG. 11, FIG. 12 and FIG. 13 are flowcharts explaining principal parts of control operations performed by the electronic control unit 40. More specifically, FIG. 10 shows a lock-up clutch control routine executed upon a start of the vehicle, FIG. 1 shows an interrupt routine executed at certain time intervals for determining whether the lock-up clutch control of FIG. 10 is to be finished, FIG. 12 is an interrupt routine executed at certain time intervals for controlling the content of a control finish flag, and FIG. 13 shows a first line pressure (original pressure) control routine executed in the case where the lock-up clutch control of FIG. 10 is executed following a finish of neutral control.

Referring to FIG. 10, after input/output signal processing known in the art is executed in step SA1, it is determined in step SA2 corresponding to the vehicle start determining unit 162 whether the vehicle is started by determining whether the brake pedal has been returned to the non-operated position. If a negative determination is made in step SA2, the above step SA1 is repeatedly executed for standby. If an affirmative determination is made in step SA2, the clutch switching valve 52 is switched to the ON position by the solenoid-operated valve 50 and the slip control valve 56 is operated by the linear solenoid valve 54 in step SA3, so that the lock-up clutch 38 is switched to a slip control state. In the next step SA4 corresponding to the target slip value determining unit 164, a required output torque is determined based on the actual acceleration stroke θacc or throttle opening θth from, for example, the relationship indicated by the solid line or broken line in FIG. 8, a target engine speed Nem for providing the engine output torque Te corresponding to the required output torque is determined, and a target slip speed Nsm (=Nem−Nin) for achieving the target engine speed Nem is calculated based on the actual turbine speed Nt, i.e., the actual input shaft rotational speed Nin. The target slip speed Nsm is determined so that the engine speed Ne during starting of the vehicle is kept substantially constant for an initial period as shown in FIG. 7, for example, and then gradually approaches the turbine speed Nt or input shaft rotational speed Nin that increases with the vehicle speed N.

Subsequently, steps SA5 through SA9 corresponding to the lock-up clutch control unit 166 are executed. More specifically, it is determined in step SA5 whether the actual slip speed Ns (=Ne−Nin) of the lock-up clutch 38 is smaller than the target slip speed Nsm. If a negative determination is made in step SA5, the torque capacity (transmitted torque) of the lock-up clutch 38 is increased by a predetermined value so as to reduce the slip speed Ns in step SA6, and step SA5 is executed again. If an affirmative determination is made in step SA5, it is determined in step SA7 whether the actual slip speed Ns of the lock-up clutch 38 is larger than the target slip speed Nsm. If a negative determination is made in step SA7, the torque capacity (transmitted torque) of the lock-up clutch 38 is reduced by a predetermined value so as to increase the slip speed Ns, and step SA7 is then executed again. If an affirmative determination is made in step SA7, it means that the actual slip speed Ns is substantially equal to the target slip speed Nsm. In this case, the current slip state of the lock-up clutch 38 is maintained or continued in step SA9.

FIG. 11 and FIG. 12 correspond to the slip control restricting unit 168. In the interrupt routine of FIG. 11, it is determined in step SW1 whether the content of a control finish flag F_{E} is set to “1”. If a negative determination is made in step SW1, the main routine, namely, the lock-up clutch slip control routine of FIG. 10, continues to be executed in step SW2. If an affirmative determination is made in step SW1, however, the main routine is finished in step SW3, the slip control of the lock-up clutch 38 is finished, and slipping of the lock-up clutch 38 during starting of the vehicle is finished or interrupted.

The routine of FIG. 12 is-intended to set the content of the control finish flag FE from “0” to “1” when the running condition of the vehicle becomes a predetermined condition, for example, a predetermined decelerating running condition associated with the probability of an engine stall, a predetermined accelerating condition associated with deterioration of the drivability, or a condition in which the work of the lock-up clutch 38 becomes equal to or larger than a predetermined value, which condition is associated with the durability of the clutch 38. In step SW11, it is determined whether the vehicle is in a running condition that increases the probability of an engine stall during starting of the vehicle. More specifically, it is determined whether at least one of the following conditions is satisfied: (a) the deceleration of the vehicle is equal to or larger than a predetermined value, (b) a braking device of the vehicle is actuated, (c) a negative change in the engine speed Ne or the rate of reduction of the engine speed Ne is equal to or larger than a predetermined value, (d) the rate of reduction of the acceleration stroke θacc or throttle opening θth is equal to or larger than a predetermined value, (e) the accelerator pedal is placed in a non-operated position, (f) a fault of a sensor, such as a vehicle speed sensor, a rotational speed sensor or an engine speed sensor, which is involved in the slip control is detected, (g) the engine speed Ne becomes equal to or lower than the turbine speed Nt of the torque converter 14, (h) the distance from a forward vehicle becomes equal to or smaller than a predetermined value, and (i) the output shaft rotational speed Nout, or the vehicle speed V, is increased to be equal to or higher than a predetermined value. When a negative determination is made in step SW11, it is determined in step SW12 whether the vehicle is in a running condition that deteriorates the drivability during starting of the vehicle. More specifically, it is determined whether at least one of the following conditions is satisfied: (a) the acceleration stroke θacc or throttle opening θth becomes equal to or larger than a predetermined value, (b) the rate of increase of the acceleration stroke θacc or throttle opening θth becomes equal to or larger than a predetermined value, (c) the vehicle starts running on an up-hill or the slope of an up-hill on which the vehicle is running becomes equal to or larger than a predetermined value, and (d) the manual operation mode of shifting of the automatic transmission 16 is selected. If a negative determination is made in step SW12, it is determined in step SW13 whether the vehicle is in a condition that reduces the durability of the friction material of the lock-up clutch 38. More specifically, it is determined whether at least one of the following conditions is satisfied: (a) the estimated (or calculated) amount of heat absorbed by the lock-up clutch 38 exceeds a predetermined value, and/or the heat absorption amount or its integral value is kept larger than a predetermined value for a predetermined length of time or longer, (b) the temperature Toil of the hydraulic fluid in the automatic transmission 16 becomes equal to or higher than a predetermined value, and (c) the acceleration of the vehicle (dV/dt) is equal to or smaller than a predetermined value a when the acceleration stroke θacc is in a predetermined range.

When negative determinations are made in all of steps SW11 through SW13, the content of the control finish flag FE is kept being “0” in step SW14. If an affirmative determination is made in any of the above steps SW11 through SW13, however, the content of the control finish flag F_{E} is set to “1”, and the slip control of the lock-up clutch 38 during starting of the vehicle is finished.

FIG. 13 corresponds to the original temperature control unit 174. In step SB1, it is determined whether neutral control by the neutral control unit 172 is finished by detecting, for example, cancellation of a braking operation (e.g., a release of the brake pedal), an operation to depress the accelerator pedal, or the like. If a negative determination is made in step SB1, the present routine is finished. If an affirmative determination is made in step SB1, it is determined in step SB2 whether the lock-up clutch control unit 166 is performing slip control upon a start of the vehicle. If a negative determination is made in step SB2, the present routine is finished. If an affirmative determination is made in step SB2, the first line pressure P11 is gradually or slowly reduced as indicated by the broken line extending from time t_{E} in FIG. 9, as compared with the conventional case as indicated by the solid line. It is then determined in step SB4 whether the first line pressure P₁₁ has reached the original appropriate value. The appropriate value is a value set for the time of non-neutral control, which value is determined according to pre-stored control rules. The above steps SB2, SB3 and SB4 are repeatedly executed to keep reducing the first line pressure P₁₁ as long as a negative determination is made in step SB4. If an affirmative determination is made in step SB4, the present routine is finished.

Here, the pressure in the apply oil chamber 18 and the pressure in the release oil chamber 20 that provide a pressure difference ΔP of the lock-up clutch 38 during slip control are determined such that the pressure in the apply oil chamber 18, which is higher than that in the release oil chamber 20, is equal to the second line pressure P₁₂, and the pressure in the release oil chamber 20 is produced by the slip control valve 56 that communicates the oil chamber 20 with a selected one of the second line pressure P₁₂ and a relatively low drain pressure or lubricant oil pressure. Thus, the slip control of the lock-up clutch 38 is influenced and disturbed by variations in the second line pressure P₁₂. Also, the hydraulic pressure that is released from the first regulating valve 62 that regulates the first line pressure P₁₁ is regulated by the second regulating valve 66 to produce the second line pressure P₁₂, and therefore the second line pressure P₁₂ is influenced by changes in the first line pressure P₁₁. In the present embodiment, however, the first line pressure P₁₁ is gradually or slowly reduced after the neutral control is finished, so that the second line pressure P₁₂ is prevented from being rapidly changed and is kept in a relatively stable state. Thus, the slip control of the lock-up clutch 38 is favorably prevented from being affected by a rapid change in the first line pressure P₁₁ as an original pressure.

According to the present embodiment, the lock-up clutch control unit 166 operates to place the lock-up clutch 38 in a slipping state when the vehicle is started. Upon a start of the vehicle, therefore, the torque received from the engine 12 is transmitted to the later stage of the power transmitting system via the lock-up clutch 38 as well as the torque converter 14, thus suppressing an increase in the speed of revolution of the engine 12 and assuring good fuel economy during starting of the vehicle, as compared with the conventional case where power is transmitted only through the torque converter 14.

According to the present embodiment, the lock-up clutch control unit 166 operates to place the lock-up clutch 38 in a slipping state so that torque larger than the transmitted torque capacity of the torque converter 14 is not transmitted from the engine 12 to the torque converter 14 upon a start of the vehicle. It is thus possible to prevent a power loss in the torque converter 14, which would otherwise occur if torque larger than the torque capacity of the torque converter 14 is received from the engine 12, thus assuring further improved fuel economy during starting of the vehicle.

The control apparatus according to the present embodiment includes the slip control restricting unit 168 that restricts or inhibits slip control of the lock-up clutch 38 by the lock-up clutch control unit 166 when the running condition of the vehicle becomes a predetermined condition. With the slip control restricting unit 168 thus provided, slipping of the lock-up clutch 38 during starting of the vehicle is restricted, for example, stopped, when the vehicle is in a decelerating running condition that increases the probability of an engine stall, or a certain accelerating condition that affects the drivability of the vehicle, or a condition in which the work of the lock-up clutch 38 becomes equal to or larger than a predetermined value, which condition affects the durability of the lock-up clutch 38. Thus, the control apparatus of the present embodiment assures a reduced probability of an engine stall of the vehicle, sufficiently high drivability or capability of starting and accelerating, and sufficiently high durability of the lock-up clutch 38.

According to the present embodiment, the slip control restricting unit 168 stops slip control of the lock-up clutch 38 by the lock-up clutch control unit 166 when it is determined that the vehicle is in a decelerating running condition, thus assuring a reduced probability or likeliness of an engine stall of the vehicle, namely, making it unlikely for the vehicle to undergo an engine stall.

According to the present embodiment, the slip control restricting unit 168 stops slip control of the lock-up clutch 38 by the lock-up clutch control unit 166 when a condition or conditions set in advance for determining a running state that increases the probability of an engine stall is/are satisfied, thus assuring a reduced probability of an engine stall of the vehicle, namely, making it unlikely for the vehicle to undergo an engine stall.

According to the present embodiment, the slip control restricting unit 168 stops slip control of the lock-up clutch 38 by the lock-up clutch control unit 166 when at least one of the following conditions is satisfied: (a) the deceleration of the vehicle is equal to or larger than the predetermined value, (b) the braking device of the vehicle is actuated, (c) a negative change in the engine speed Ne is equal to or larger than the predetermined value, (d) the rate of reduction of the acceleration stroke θacc or throttle opening θth is equal to or greater than the predetermined value, (e) the accelerator pedal is placed in a non-operated position, (f) a fault of a sensor, such as a vehicle speed sensor, a rotational speed sensor or an engine speed sensor, is detected, (g) the engine speed Ne becomes equal to or lower than the turbine speed Nt of the torque converter 14, (h) the distance from the forward vehicle becomes equal to less than the predetermined value, and (i) the output shaft rotational speed Nout is increased to be equal to or higher than the predetermined value. Since the slip control of the lock-up clutch 38 is stopped if such a condition(s) that increases the probability of an engine stall is satisfied, the vehicle is less likely to suffer from an engine stall.

According to the present embodiment, the slip control restricting unit 168 restricts, for example, stops, slip control of the lock-up clutch 38 by the lock-up clutch control unit 166 when it detects a certain accelerating condition of the vehicle, thus assuring sufficiently high drivability (i.e., capability of starting and accelerating) of the vehicle.

According to the present embodiment, the slip control restricting unit 168 restricts slip control of the lock-up clutch 38 by the lock-up clutch control unit 166 when it determines that the vehicle is in a condition that deteriorates the drivability of the vehicle, thus assuring sufficiently high drivability (i.e., capability of starting and accelerating) of the vehicle.

According to the present embodiment, the slip control restricting unit 168 reduces the torque capacity of the lock-up clutch 38 that is in a slipping state when the acceleration stroke θacc or throttle opening θth becomes equal to or larger than the predetermined value, and stops slip control of the lock-up clutch 38 by the lock-up clutch control unit 166 when the rate of increase of the acceleration stroke θacc or throttle opening θth becomes equal to or larger than the predetermined value. The slip control restricting unit 168 also reduces the torque capacity of the lock-up clutch 38 that is in a slipping state in accordance with the slope of the up-hill on which the vehicle is running, and stops slip control of the lock-up clutch 38 by the lock-up clutch control unit 166 when the slope of the up-hill becomes equal to or larger than the predetermined value. The slip control restricting unit 168 also stops slip control of the lock-up clutch 38 by the lock-up clutch control unit 166 when the manual operation mode of shifting of the automatic transmission 16 is selected. Thus, the control apparatus of the present embodiment stops slip control of the lock-up clutch 38 when a condition(s) that deteriorates the drivability of the vehicle is satisfied, thus assuring a high capability of the vehicle to start and accelerate.

According to the present embodiment, the slip control restricting unit 168 stops slip control of the lock-up clutch 38 by the lock-up clutch control unit 166 when the work of the lock-up clutch 38 becomes equal to or larger than the predetermined value, thus assuring sufficiently high drivability (i.e., capability of starting and accelerating) of the vehicle.

According to the present embodiment, the slip control restricting unit 168 stops slip control of the lock-up clutch 38 by the lock-up clutch control unit 166 when a condition or conditions set in advance for determining an operating state that reduces the durability of the friction material of the lock-up clutch 38 is/are satisfied, thus assuring sufficiently high durability of the lock-up clutch 38.

According to the present embodiment, the slip control restricting unit 168 estimates an amount of heat absorbed by the lock-up clutch 38, and stops slip control of the lock-up clutch 38 by the lock-up clutch control unit 166 when the estimated heat absorption amount exceeds the predetermined value, and/or the heat absorption amount or its integral value is kept larger than the predetermined value for the predetermined length of time or longer. The slip control restricting unit 168 also stops slip control of the lock-up clutch 38 by the lock-up clutch control unit 166 when the temperature Toil of the hydraulic fluid of the automatic transmission 16 is equal to or higher than the predetermined value. The slip control restricting unit 168 also stops slip control of the lock-up clutch 38 by the lock-up clutch control unit 166 if the acceleration of the vehicle (dV/dt) is equal to or smaller than the predetermined value a when the acceleration stroke θacc is in the predetermined range. Thus, the control apparatus of the present embodiment assures sufficiently high durability of the lock-up clutch 38.

The control apparatus of the present embodiment includes (a) the automatic transmission 16 operatively coupled to the output side of the torque converter 14 equipped with the lock-up clutch 38, (b) the neutral control unit 172 that releases the clutch C1 (hydraulic friction device) for releasing or disconnecting the power transmission path in the automatic transmission 16 when the vehicle is stopped, and (c) the original pressure control unit 174 that raises the first line pressure P₁₁ as an original pressure of the clutch C1, brake B2, and the like by a predetermined level during neutral control under which the neutral control unit 172 performs control for releasing the power transmission path of the automatic transmission 16, and gradually reduces the original pressure as indicated by the broken line in FIG. 9 when the releasing control or neutral control is finished. In this connection, the control hydraulic pressure used for control of the lock-up clutch 38 is regulated from the original pressure that is controlled by the original pressure control unit 174. When the lock-up clutch 38 of the torque converter 14 is controlled to be in a slipping state by the lock-up clutch control unit 166 upon a start of the vehicle immediately after the neutral control, therefore, a rapid change in the original pressure used for the slip control of the lock-up clutch 38 is avoided, and disturbance of the slip control due to such a rapid change in the original pressure is favorably eliminated.

Next, another embodiment of the invention will be described. In the following description, the same reference numerals as used in the previous embodiment will be used for identifying the same components or portions, of which no detailed description will be provided.

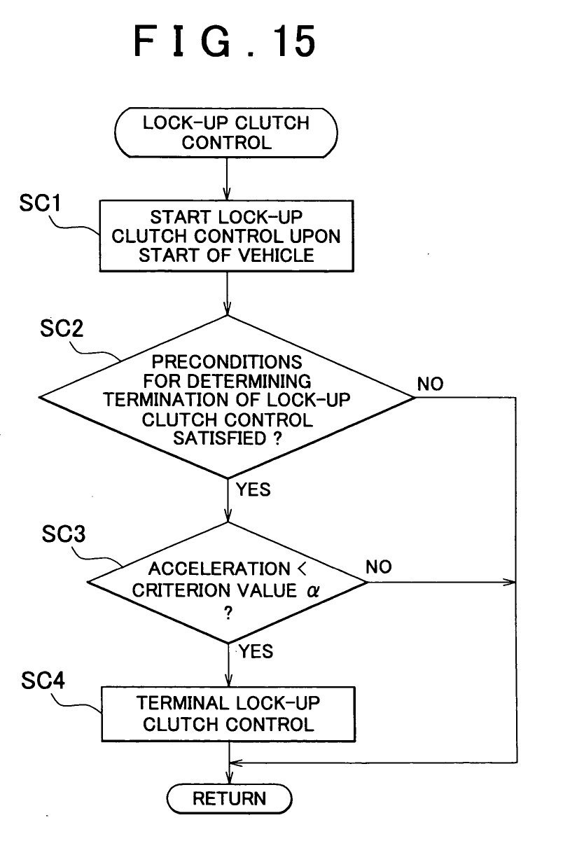

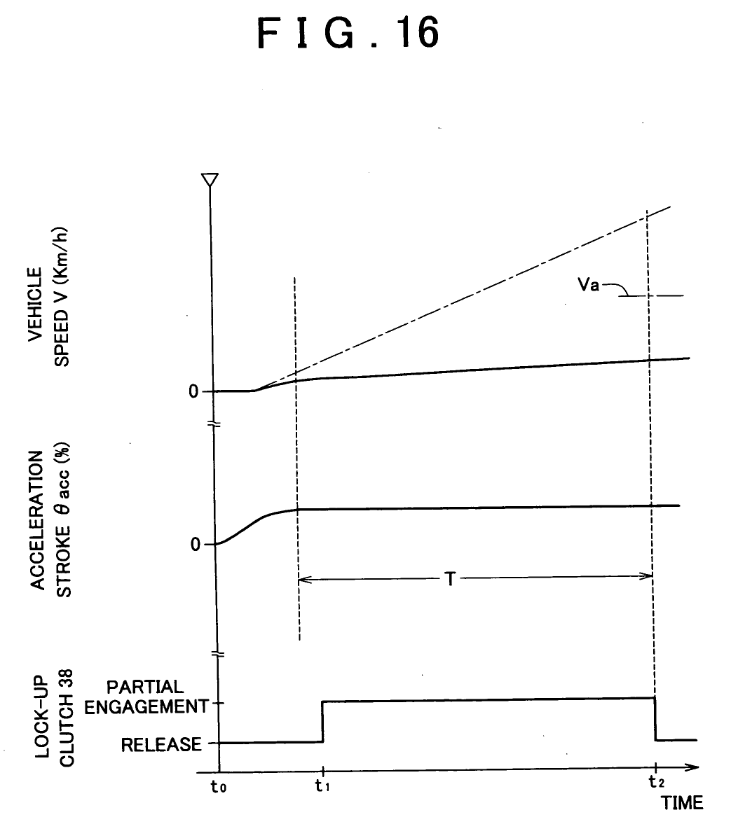

FIG. 15 is a flowchart explaining control operations of the lock-up clutch control unit 166 and the slip control restricting unit 168. More specifically, the flowchart of FIG. 15 illustrates in detail a control process for restricting slip control at the time of a start of the vehicle so as to prevent or suppress reduction of the durability of the friction material. FIG. 15 shows a control routine in which termination of slip control is determined when an excessively large load is applied to the lock-up clutch 38 during lock-up clutch control for partially engaging the lock-up clutch 38 upon a start of the vehicle. FIG. 16 is a time chart explaining the control operation of FIG. 15.

Referring to FIG. 15 and FIG. 16, when the accelerator pedal is operated to start an accelerating operation of the vehicle at point to in time in FIG. 16, step SC1 corresponding to the lock-up clutch control unit 166 is executed to initiate lock-up clutch control upon a start of the vehicle in response to the accelerating operation, and partially engage the lock-up clutch 38, as shown in FIG. 10 described above. The start of the lock-up clutch control, i.e., partial engagement of the lock-up clutch 38, takes place at t₁ in FIG. 16. Subsequently, steps SC2-SC4 corresponding to the slip control restricting unit 168 are executed. In step SC2, it is determined whether certain preconditions for determining termination of slip control are satisfied. The preconditions may be determined to be satisfied when, for example, the vehicle is in an accelerating state with the acceleration stroke θacc being equal to or larger than a predetermined value, the vehicle is in a warm-up state in which the coolant temperature of the engine 12 and/or the working oil temperature of the automatic transmission 16 is/are equal to or higher than predetermined values, and no fault or abnormality occurs in mechanical parts, such as rotational speed sensors, temperature sensors and control valves. If a negative determination is made in step SC2, the present routine is finished. If an affirmative determination is made in step SC2, it is determined in step SC3 whether the acceleration (dV/dt) of the vehicle measured upon a lapse of a set period of time T from the actual start of the vehicle at around time t₁ is equal to or smaller than a predetermined criterion value α. In FIG. 16, t₂ indicates a point in time at which the set time T passes from the start of the vehicle. Since the acceleration (dV/dt) of the vehicle measured upon a lapse of the set period of time T is equal to a value obtained by dividing the vehicle speed V measured upon a lapse of the set time T by the set time T, it may be determined in step SC3 whether the vehicle speed V measured upon a lapse of the set time T is equal to or lower than a predetermined criterion value Va.

If a negative determination is made in step SC3, the present routine is finished. If an affirmative determination is made in step SC3, the vehicle is in an operating state in which an excessively large friction load is applied to the lock-up clutch 38 due to high running resistance of the vehicle. In this case, step SC4 is executed to terminate the lock-up clutch control started in step SC1, so as to protect the lock-up clutch 38 against reduction of the durability of the clutch 38.

In the present embodiment, the control apparatus determines that the work of the lock-up clutch 38 is equal to or larger than a predetermined value when the acceleration (dV/dt) of the vehicle or the vehicle speed V measured upon a lapse of the set time T is equal to or smaller or lower than the criterion value a or Va, and terminates lock-up clutch control executed upon a start of the vehicle based on this determination, thus assuring improved durability of the lock-up clutch 38.

While some exemplary embodiments of the invention have been described in detail with reference to the drawings, it is to be understood that the invention is not limited to the details of the illustrated embodiments, but may be otherwise embodied.

In the illustrated embodiment, the actual slip speed Ns of the lock-up clutch 38 is controlled to be equal to the target slip speed Nsm that is sequentially calculated during starting of the vehicle, according to the above-indicated control equation (6). However, the lock-up clutch 38 may be slipped during starting of the vehicle by utilizing easier or simpler control than that as described above, for example, by maintaining a pre-set or predetermined pressure difference ΔP or slip speed Ns for a predetermined period. In sum, slip control of the lock-up clutch 38 may be performed in any manner provided that the output torque Te of the engine 12 is transmitted to the input shaft 32 of the automatic transmission 16 via the lock-up clutch 38 as well as the torque converter 14 when the vehicle is started.

In the illustrated embodiment, the control equation (6) is used to carry out feedback control of a closed loop so as to control the actual slip speed Ns of the lock-up clutch 38 to be equal to the target slip speed Nsm sequentially calculated during starting of the vehicle. However, the closed-loop control may be replaced by open-loop control under which slip control is performed according to pre-stored map values for achieving the target slip speed Nsm.

In the illustrated embodiment, the actual slip speed Ns of the lock-up clutch 38 is controlled according to the control equation (6) so that the slip speed Ns becomes equal to the target slip speed Nsm that is sequentially calculated during starting of the vehicle. However, the slip speed Ns of the lock-up clutch 38, or the pressure difference ΔP of the lock-up clutch 38, may be controlled so that the actual engine speed Ne becomes equal to a sequentially calculated target engine speed Nem.

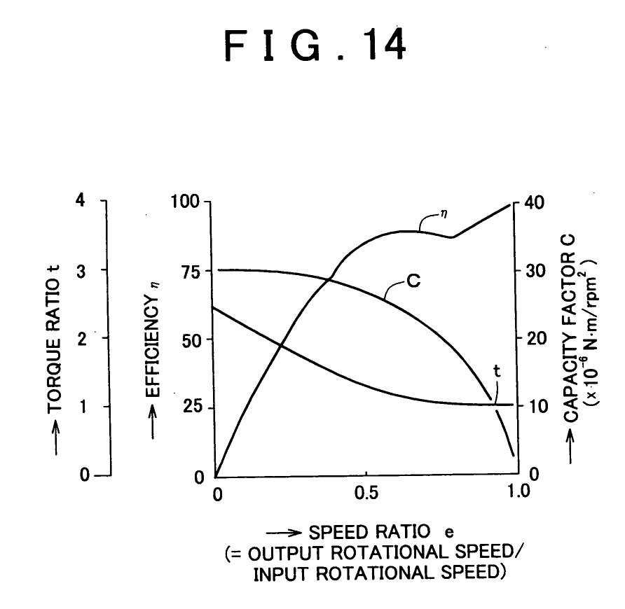

In the illustrated embodiment, the actual slip speed Ns of the lock-up clutch 38 is controlled according to the control equation (6) so that the slip speed Ns becomes equal to the target slip speed Nsm that is sequentially calculated during starting of the vehicle. However, a target transmitted torque may be sequentially determined based on the capacity factor C (×10⁻⁶ N·m/rpm²) of the torque converter 14 from a pre-stored relationship as indicated in, for example, FIG. 14, such that the target transmitted torque is equal to or smaller by a predetermined value than the torque capacity represented by the capacity factor C, and the slip speed Ns of the lock-up clutch 38, i.e., the pressure difference ΔP of the lock-up clutch 38, may be controlled so that the actual transmitted torque of the torque converter 14 becomes equal to the target transmitted torque.

While the torque converter 14 is used as a hydraulic power transmitting device in the illustrated embodiment, a fluid coupling that does not include the stator 14s may be used as the hydraulic power transmitting device.

While some embodiments of the invention have been illustrated above, it is to be understood that the invention is not limited to the details of the illustrated embodiments, but may be embodied with various changes, modifications or improvements, which may occur to those skilled in the art without departing from the spirit and scope of the invention.

What is claimed is:

1. A control apparatus for controlling a lock-up clutch of a vehicle having a hydraulic power transmitting device equipped with the lock-up clutch, the hydraulic power transmitting device being disposed on an output side of an engine of the vehicle, comprising:
a lock-up clutch control unit that places the lock-up clutch in a slipping state when the vehicle is started.

2. The control apparatus according to claim 1, wherein the lock-up clutch control unit places the lock-up clutch in the slipping state so as to prevent the hydraulic power transmitting device from receiving, from the engine, torque that is larger than a transmitted torque capacity of the hydraulic power transmitting device when the vehicle is started.

3. The control apparatus according to claim 2, further comprising a slip control restricting unit that restricts slip control of the lock-up clutch by the lock-up clutch control unit when a running condition of the vehicle becomes a predetermined condition.

4. The control apparatus according to claim 1, further comprising a slip control restricting unit that restricts slip control of the lock-up clutch by the lock-up clutch control unit when a running condition of the vehicle becomes a predetermined condition.

5. The control apparatus according to claim 4, wherein the slip control restricting unit stops slip control of the lock-up clutch by the lock-up clutch control unit when the vehicle is in a decelerating running condition.

6. The control apparatus according to claim 5, wherein the slip control restricting unit stops slip control of the lock-up clutch by the lock-up clutch control unit when at least one of the following conditions is satisfied: (a) a deceleration of the vehicle is equal to or larger than a predetermined value, (b) a braking device of the vehicle is actuated, (c) a negative change in an engine speed is equal to or larger than a predetermined value, (d) a rate of reduction of an acceleration stroke is equal to or greater than a predetermined value, (e) an accelerator pedal is in a non-operated position, (f) a fault of at least one of a vehicle speed sensor, a rotational speed sensor and an engine speed sensor is detected, (g) the engine speed becomes equal to or lower than a turbine speed of the hydraulic power transmitting device, (h) a distance from a forward vehicle becomes equal to less than a predetermined value, and (i) a vehicle speed is increased to be equal to or higher than a predetermined value.

7. The control apparatus according to claim 4, wherein the slip control restricting unit stops slip control of the lock-up clutch by the lock-up clutch control unit when at least one condition set in advance for determining an operating state of the vehicle that increases the probability of an engine stall is satisfied.

8. The control apparatus according to claim 7, wherein the slip control restricting unit stops slip control of the lock-up clutch by the lock-up clutch control unit when at least one of the following conditions is satisfied: (a) a deceleration of the vehicle is equal to or larger than a predetermined value, (b) a braking device of the vehicle is actuated, (c) a negative change in an engine speed is equal to or larger than a predetermined value, (d) a rate of reduction of an acceleration stroke is equal to or greater than a predetermined value, (e) an accelerator pedal is in a non-operated position, (f) a fault of at least one of a vehicle speed sensor, a rotational speed sensor and an engine speed sensor is detected, (g) the engine speed becomes equal to or lower than a turbine speed of the hydraulic power transmitting device, (h) a distance from a forward vehicle becomes equal to less than a predetermined value, and (i) a vehicle speed is increased to be equal to or higher than a predetermined value.

9. The control apparatus according to claim 4, wherein the slip control restricting unit restricts slip control of the lock-up clutch by the lock-up clutch control unit when the vehicle is in a predetermined accelerating condition.

10. The control apparatus according to claim 9, wherein the slip control restricting unit reduces a torque capacity of the lock-up clutch that is in a slipping state when an acceleration stroke becomes equal to or larger than a predetermined value, stops slip control of the lock-up clutch by the lock-up clutch control unit when a rate of increase of the acceleration stroke becomes equal to or larger than a predetermined value, reduces the torque capacity of the lock-up clutch that is in a slipping state in accordance with a slope of an up-hill on which the vehicle is running, stops slip control of the lock-up clutch by the lock-up clutch control unit when the slope of the up-hill becomes equal to or larger than a predetermined value, or stops slip control of the lock-up clutch by the lock-up clutch control unit when a manual operation mode is selected in which a speed ratio of an automatic transmission provided on an output side of the hydraulic power transmitting device is changed.

11. The control apparatus according to claim 4, wherein the slip control restricting unit restricts slip control of the lock-up clutch by the lock-up clutch control unit when the vehicle is in an operating state that deteriorates the drivability of the vehicle.

12. The control apparatus according to claim 11, wherein the slip control restricting unit reduces a torque capacity of the lock-up clutch that is in a slipping state when an acceleration stroke becomes equal to or larger than a predetermined value, stops slip control of the lock-up clutch by the lock-up clutch control unit when a rate of increase of the acceleration stroke becomes equal to or larger than a predetermined value, reduces the torque capacity of the lock-up clutch that is in a slipping state in accordance with a slope of an up-hill on which the vehicle is running, stops slip control of the lock-up clutch by the lock-up clutch control unit when the slope of the up-hill becomes equal to or larger than a predetermined value, or stops slip control of the lock-up clutch by the lock-up clutch control unit when a manual operation mode is selected in which a speed ratio of an automatic transmission provided on an output side of the hydraulic power transmitting device is changed.

13. The control apparatus according to claim 4, wherein the slip control restricting unit stops slip control of the lock-up clutch by the lock-up clutch control unit when a work of the lock-up clutch becomes equal to or larger than a predetermined value.

14. The control apparatus according to claim 13, wherein the slip control restricting unit estimates an amount of heat absorbed by the lock-up clutch, and stops slip control of the lock-up clutch by the lock-up clutch control unit when at least one of the following conditions is satisfied: (a) the estimated heat absorption amount exceeds a predetermined value, and (b) the heat absorption amount or an integral value thereof is kept larger than a predetermined value for a predetermined length of time or longer, or stops slip control of the lock-up clutch by the lock-up clutch control unit when an oil temperature of an automatic transmission provided in the vehicle becomes equal to or higher than a predetermined value, or stops slip control of the lock-up clutch by the lock-up clutch control unit if an acceleration of the vehicle is equal to or smaller than a predetermined value when an acceleration stroke is in a predetermined range.

15. The control apparatus according to claim 4, wherein the slip control restricting unit stops slip control of the lock-up clutch by the lock-up clutch control unit when at least one condition set in advance for determining an operating state that reduces the durability of a friction material of the lock-up clutch is satisfied.

16. The control apparatus according to claim 15, wherein the slip control restricting unit estimates an amount of heat absorbed by the lock-up clutch, and stops slip control of the lock-up clutch by the lock-up clutch control unit when at least one of the following conditions is satisfied: (a) the estimated heat absorption amount exceeds a predetermined value, and (b) the heat absorption amount or an integral value thereof is kept larger than a predetermined value for a predetermined length of time or longer, or stops slip control of the lock-up clutch by the lock-up clutch control unit when an oil temperature of an automatic transmission provided in the vehicle becomes equal to or higher than a predetermined value, or stops slip control of the lock-up clutch by the lock-up clutch control unit if an acceleration of the vehicle is equal to or smaller than a predetermined value when an acceleration stroke is in a predetermined range.

17. The control apparatus according to claim 1, wherein the vehicle further includes an automatic transmission operatively coupled to an output side of the hydraulic power transmitting device equipped with the lock-up clutch, the control apparatus further comprising:
a neutral control unit that substantially releases a hydraulic friction device for releasing a power transmission path of the automatic transmission when the vehicle is stopped; and
an original pressure control unit that raises an original pressure of the hydraulic friction device by a predetermined level during control of the neutral control unit for releasing the power transmission path of the automatic transmission, and gradually reduces the original pressure after the releasing control of the neutral control unit is finished,
wherein a control hydraulic pressure used by the lock-up clutch control unit for control of the lock-up clutch is produced by regulating the original pressure controlled by the original pressure control unit.

18. A control apparatus for controlling a lock-up clutch of a vehicle having (a) a hydraulic power transmitting device equipped with the lock-up clutch for directly coupling an input rotary member with an output rotary member, and (b) an automatic transmission operatively coupled to an output side of the hydraulic power transmitting device equipped with the lock-up clutch, for establishing a selected one of a plurality of gear stages by changing a combination of operating states of a plurality of hydraulic friction devices, comprising:
a neutral control unit that places at least one of the hydraulic friction devices that releases a power transmission path of the automatic transmission when the vehicle is stopped in a released state or a slipping state; and
an original pressure control unit that raises an original pressure of said at least one hydraulic friction device by a predetermined level during neutral control of the neutral control unit, and gradually reduces the original pressure after the neutral control is finished.

19. A method for controlling a lock-up clutch of a vehicle having a hydraulic power transmitting device equipped with the lock-up clutch, the hydraulic power transmitting device being disposed on an output side of an engine of the vehicle, wherein:
slip control is performed to place the lock-up clutch in a slipping state when the vehicle is started.

20. The method according to claim 19, wherein the lock-up clutch is placed in the slipping state so as to prevent the hydraulic power transmitting device from receiving, from the engine, torque that is larger than a transmitted torque capacity of the hydraulic power transmitting device when the vehicle is started.

21. The method according to claim 20, wherein the slip control of the lock-up clutch is restricted when a running condition of the vehicle becomes a predetermined condition.

22. The method according to claim 19, wherein the slip control of the lock-up clutch is restricted when a running condition of the vehicle becomes a predetermined condition.

23. The method according to claim 22, wherein the slip control of the lock-up clutch is stopped when the vehicle is in a decelerating running condition.

24. The method according to claim 23, wherein the slip control of the lock-up clutch is stopped when at least one of the following conditions is satisfied: (a) a deceleration of the vehicle is equal to or larger than a predetermined value, (b) a braking device of the vehicle is actuated, (c) a negative change in an engine speed is equal to or larger than a predetermined value, (d) a rate of reduction of an acceleration stroke is equal to or greater than a predetermined value, (e) an accelerator pedal is in a non-operated position, (f) a fault of at least one of a vehicle speed sensor, a rotational speed sensor and an engine speed sensor is detected, (g) the engine speed becomes equal to or lower than a turbine speed of the hydraulic power transmitting device, (h) a distance from a forward vehicle becomes equal to less than a predetermined value, and (i) a vehicle speed is increased to be equal to or higher than a predetermined value.

25. The method according to claim 22, wherein the slip control of the lock-up clutch is stopped when at least one condition set in advance for determining an operating state of the vehicle that increases the probability of an engine stall is satisfied.

26. The method according to claim 25, wherein the slip control of the lock-up clutch is stopped when at least one of the following conditions is satisfied: (a) a deceleration of the vehicle is equal to or larger than a predetermined value, (b) a braking device of the vehicle is actuated, (c) a negative change in an engine speed is equal to or larger than a predetermined value, (d) a rate of reduction of an acceleration stroke is equal to or greater than a predetermined value, (e) an accelerator pedal is in a non-operated position, (f) a fault of at least one of a vehicle speed sensor, a rotational speed sensor and an engine speed sensor is detected, (g) the engine speed becomes equal to or lower than a turbine speed of the hydraulic power transmitting device, (h) a distance from a forward vehicle becomes equal to less than a predetermined value, and (i) a vehicle speed is increased to be equal to or higher than a predetermined value.

27. The method according to claim 22, wherein the slip control of the lock-up clutch is restricted when the vehicle is in a predetermined accelerating condition.

28. The method according to claim 27, wherein a torque capacity of the lock-up clutch that is in a slipping state is reduced when an acceleration stroke becomes equal to or larger than a predetermined value, or the slip control of the lock-up clutch is stopped when a rate of increase of the acceleration stroke becomes equal to or larger than a predetermined value, or the torque capacity of the lock-up clutch that is in a slipping state is reduced in accordance with a slope of an up-hill on which the vehicle is running, or the slip control of the lock-up clutch is stopped when the slope of the up-hill becomes equal to or larger than a predetermined value, or the slip control of the lock-up clutch is stopped when a manual operation mode is selected in which a speed ratio of an automatic transmission provided on an output side of the hydraulic power transmitting device is changed.

29. The method according to claim 22, wherein the slip control of the lock-up clutch is restricted when the vehicle is in an operating state that deteriorates the drivability of the vehicle.

30. The method according to claim 29, wherein a torque capacity of the lock-up clutch that is in a slipping state is reduced when an acceleration stroke becomes equal to or larger than a predetermined value, or the slip control of the lock-up clutch is stopped when a rate of increase of the acceleration stroke becomes equal to or larger than a predetermined value, or the torque capacity of the lock-up clutch that is in a slipping state is reduced in accordance with a slope of an up-hill on which the vehicle is running, or the slip control of the lock-up clutch is stopped when the slope of the up-hill becomes equal to or larger than a predetermined value, or the slip control of the lock-up clutch is stopped when a manual operation mode is selected in which a speed ratio of an automatic transmission provided on an output side of the hydraulic power transmitting device is changed.

31. The method according to claim 22, wherein the slip control of the lock-up clutch is stopped when a work of the lock-up clutch becomes equal to or larger than a predetermined value.

32. The method according to claim 31, wherein an amount of heat absorbed by the lock-up clutch is estimated, and the slip control of the lock-up clutch is stopped when at least one of the following conditions is satisfied: (a) the estimated heat absorption amount exceeds a predetermined value, and (b) the heat absorption amount or an integral value thereof is kept larger than a predetermined value for a predetermined length of time or longer, or the slip control of the lock-up clutch is stopped when an oil temperature of an automatic transmission provided in the vehicle becomes equal to or higher than a predetermined value, or the slip control of the lock-up clutch is stopped if an acceleration of the vehicle is equal to or smaller than a predetermined value when an acceleration stroke is in a predetermined range.

33. The method according to claim 22, wherein the slip control of the lock-up clutch is stopped when at least one condition set in advance for determining an operating state that reduces the durability of a friction material of the lock-up clutch is satisfied.

34. The method according to claim 33, wherein an amount of heat absorbed by the lock-up clutch is estimated, and the slip control of the lock-up clutch is stopped when at least one of the following conditions is satisfied: (a) the estimated heat absorption amount exceeds a predetermined value, and (b) the heat absorption amount or an integral value thereof is kept larger than a predetermined value for a predetermined length of time or longer, or the slip control of the lock-up clutch is stopped when an oil temperature of an automatic transmission provided in the vehicle becomes equal to or higher than a predetermined value, or the slip control of the lock-up clutch is stopped if an acceleration of the vehicle is equal to or smaller than a predetermined value when an acceleration stroke is in a predetermined range.

35. The method according to claim 19, wherein:
the vehicle further includes an automatic transmission operatively coupled to an output side of the hydraulic power transmitting device equipped with the lock-up clutch;
a hydraulic friction device for releasing a power transmission path of the automatic transmission is substantially released under neutral control when the vehicle is stopped;
an original pressure of the hydraulic friction device is raised by a predetermined level during the neutral control for releasing the power transmission path of the automatic transmission, and the original pressure is gradually reduced after the neutral control is finished; and
a control hydraulic pressure used for the slip control of the lock-up clutch is produced by regulating the original pressure.

36. A method for controlling a lock-up clutch of a vehicle having (a) a hydraulic power transmitting device equipped with the lock-up clutch for directly coupling and input rotary member with an output rotary member, and (b) an automatic transmission operatively coupled to an output side of the hydraulic power transmitting device equipped with the lock-up clutch, for establishing a selected one of a plurality of gear stages by changing a combination of operating states of a plurality of hydraulic friction devices, comprising the steps of:
performing neutral control to at least one of the hydraulic friction devices that releases a power transmission path of the automatic transmission when the vehicle is stopped in a released state or a slipping state; and
raising an original pressure of said at least one hydraulic friction device by a predetermined level during the neutral control, and gradually reducing the original pressure after the neutral control is finished.
